(19) United States
(12) Patent Application Publication
(10) Pub. No.: US 2017/0235039 A1
(43) Pub. Date: Aug. 17, 2017

(54) Integrated Back Light Unit Including Non-Uniform Light Guide Unit

(71) Applicant: GLO AB, Lund (SE)

(72) Inventors: Ronald KANESHIRO, Los Altos, CA (US); Ping WANG, Sunnyvale, CA (US); Frank PATTERSON, Pleasanton, CA (US); Clinton CARLISLE, Palo Alto, CA (US); Michael JANSEN, Palo Alto, CA (US)

(21) Appl. No.: 15/502,988

(22) PCT Filed: Aug. 10, 2015
(86) PCT No.: PCT/US2015/044488

§ 371 Date: Feb. 9, 2017

Related U.S. Application Data
(60) Provisional application No. 62/036,420, filed on Aug. 12, 2014.
(60) Provisional application No. 62/049,523, filed on Sep. 12, 2014.
(60) Provisional application No. 62/096,247, filed on Dec. 23, 2014.
(60) Provisional application No. 62/169,795, filed on Jun. 2, 2015.

(51) Int. Cl. F21V 8/00

(52) U.S. Cl. CPC G02B 6/0061; G02B 6/0031; G02B 6/0068; G02B 6/0055; G02B 6/0073; G02B 6/0036

(57) ABSTRACT

An integrated back light unit can include a light guide plate having a non-uniform distribution of extraction features. The non-uniform distribution of the extraction features can be provided by an extraction-feature-free region in proximity to a light emitting device, and/or by a variable density of the extraction features that changes with distance from the light emitting device. Additionally or alternatively, the light guide unit can include a heterogeneous reflectivity surface that has a different reflectivity at proximity to the light emitting device assembly than at a distal portion of the light guide unit. The different reflectivity may be provided by a specular reflective material, diffusive reflective material, or a light absorbing material. The non-uniform distribution of extraction features and/or the heterogeneous reflectivity surface can be employed to enhance brightness uniformity of the reflective light and/or to control the temperature distribution within the light guide unit.

### RELATED APPLICATION

This application claims the benefit of priority to U.S. Provisional Application Nos. 62/036,420, filed on Aug. 12, 2014; 62/049,523, filed on Sep. 12, 2014; 62/096,247, filed Dec. 23, 2014; and 62/169,795, filed Jun. 2, 2015, the entire content of which applications are incorporated herein by reference.

### FIELD

The embodiments of the invention are directed generally to semiconductor light emitting devices and specifically to an integrated back light unit, and a method of manufacturing the same.

### BACKGROUND

Light emitting devices such as light emitting diodes (LEDs) are used in electronic displays, such as liquid crystal displays in laptops or LED televisions. Conventional LED units are fabricated by mounting LEDs to a substrate, encapsulating the mounted LEDs and then optically coupling the encapsulated LEDs to an optical waveguide. Some of the problems that conventional LED units can suffer include local heating of the optical waveguides in regions proximal to the interface with LED light emitting device assemblies, variations in the uniformity of brightness of light reflected from a light guide plate, and/or general lack of uniformity in light intensity distribution and/or temperature distribution across the light guide plate.

### SUMMARY

An integrated back light unit can include a light guide unit having a non-uniform distribution of extraction features that reflect the light from a light emitting device in a direction substantially perpendicular to the initial direction of the light from the light emitting device. The non-uniform distribution of the extraction features can be provided by an extraction-feature-free region in proximity to the light emitting device assembly, and/or by a variable density of the extraction features that changes with distance from the light emitting device. Additionally or alternatively, the light guide unit can include a heterogeneous reflectivity surface that has a different reflectivity at proximity to the light emitting device than at a distal portion of the light guide unit. The different reflectivity may be provided by a specular reflective material, diffusive reflective material, or a light absorbing material. The non-uniform distribution of extraction features and/or the heterogeneous reflectivity surface can be employed to enhance brightness uniformity of the reflective light and/or to control the temperature distribution within the light guide unit.

According to an aspect of the present disclosure, an integrated back light unit is provided, which includes a light emitting device assembly containing a support containing an interstice and at least one light emitting device located within the interstice, and further includes a light guide unit optically coupled to the at least one light emitting device and having a proximal portion located within, or adjacent to, the interstice and a distal portion extending outside the interstice. The light guide unit includes a plurality of extraction features configured to reflect light from the at least one light emitting device. A nearest-neighbor distance among the plurality of extraction features is non-uniform and monotonically decreases with an increase in a distance from the at least one light emitting device.

According to another aspect of the present disclosure, an integrated back light unit is provided, which includes a light emitting device assembly including a support containing an interstice and at least one light emitting device located within the interstice, and further includes a light guide unit optically coupled to the at least one light emitting device and having a proximal portion located within, or adjacent to, the interstice and a distal portion extending outside the interstice. The light guide unit includes a plurality of extraction features configured to reflect light from the at least one light emitting device, and a heterogeneous surface including a distal surface that underlies the plurality of extraction features and a proximal surface that is closer to the at least one light emitting device and having a reflectivity different from the distal surface.

According to yet another aspect of the present disclosure, a method of forming an integrated back light unit is provided. A light emitting device assembly is provided, which includes a support containing an interstice and at least one light emitting device embedded in, or located adjacent to, the interstice. A light guide unit is optically coupled to the at least one light emitting device. The light guide unit has a non-uniform distribution of a plurality of extraction features configured to reflect light from the at least one light emitting device. The light guide unit is disposed such that a nearest-neighbor distance among the plurality of extraction features monotonically decreases with a distance from the at least one light emitting device.

According to still another aspect of the present disclosure, a method of forming an integrated back light unit is provided. A light emitting device assembly is provided, which includes a support containing an interstice and at least one light emitting device embedded in, or located adjacent to, the interstice. A light guide unit is optically coupled to the at least one light emitting device such that a proximal portion of the light guide unit is disposed within, or adjacent to, the interstice and a distal portion of the light guide unit extends outside the interstice. The light guide unit includes a plurality of extraction features configured to reflect light from the at least one light emitting device, and further includes a heterogeneous surface. The heterogeneous surface includes a distal surface that underlies the plurality of extraction features, and a proximal surface that is closer to the at least one light emitting device and having a reflectivity different from the distal surface.

According to even another embodiment of the present disclosure, an integrated back light unit is provided, which includes a light emitting device assembly comprising a support containing an interstice and at least one light emitting device located within the interstice. The integrated back light unit further includes a light guide unit optically coupled to the at least one light emitting device and having a proximal portion located within, or adjacent to, the interstice and a distal portion extending outside the interstice. The light guide unit comprises a plurality of extraction features which are printed geometrical features on a surface of a light guide plate to affect the extraction and transmission of photons traveling within the light guide plate. The printed feature are optimized to absorb, reflect, or partially reflect and absorb the photons, at least one of the printed geometrical features having a shape selected from a rectilinear shape, a curvilinear shape, a polygonal shape, and a curved shape and optimized to obtain a desired optical emission pattern from the surface of the light guide plate.

According to further another embodiment of the present disclosure, an integrated back light unit is provided, which comprises a light emitting device assembly comprising a support containing an interstice and at least one light emitting device located within the interstice; and a light guide unit optically coupled to the at least one light emitting device and having a proximal portion located within, or adjacent to, the interstice and a distal portion extending outside the interstice. The light guide unit comprises a plurality of grooves having a linear groove density that increases with a distance from the proximal portion, the linear groove density being a total number of grooves per unit length as counted within a plane containing the plurality of grooves and along a direction perpendicular to the distance from the proximal portion.

According to another embodiment of the present disclosure, an integrated back light unit is provided, which comprises a light emitting device assembly comprising a light bar, a printed circuit adaptor, and a light guide plate. The light bar comprises a substrate strip comprising metal interconnect structures, a linear array of light emitting devices located on a front side of the substrate strip, and an encapsulant material layer located on the substrate strip and encapsulating the light emitting devices. A first lengthwise sidewall of the substrate strip and a first lengthwise sidewall of the encapsulant material layer are within a first plane, a second lengthwise sidewall of the substrate strip and a second lengthwise sidewall of the encapsulant material layer are within a second plane that is parallel to the first plane. The printed circuit adaptor comprises an electrical connector configured to provide electrical connections to the lightbar. The light guide plate is optically coupled to the light emitting devices and comprises a plurality of extraction features configured to reflect light from the light emitting devices.

According to even another aspect of the present disclosure, a method of fabricating a light emitting device assembly is provided. A plurality of light emitting devices is bonded onto a printed circuit board substrate. The light emitting devices are encapsulated by forming a transparent encapsulant layer on the plurality of light emitting devices. Lightbars are formed by dicing an assembly of the printed circuit board substrate, the plurality of light emitting devices, and the transparent encapsulant layer. A printed circuit adaptor is attached to a lightbar. The printed circuit adaptor comprises an electrical connector configured to provide electrical connections to the lightbar.

According to further another aspect of the present disclosure, a method of forming an integrated back light unit is provided. A lightbar is provided, which comprises a substrate strip, a linear array of light emitting devices located on a front side of the substrate strip, and an encapsulant material layer located on the substrate strip and encapsulating the light emitting devices. A light emitting device assembly is formed by attaching the lightbar to a printed circuit adaptor comprising an electrical connector configured to provide electrical connections to the lightbar. A light guide plate is optically coupled to the light emitting devices by affixing the light guide plate to a top surface of the encapsulant material layer, the light guide plate comprising a plurality of extraction features configured to reflect light from the at least one light emitting device.

### BRIEF DESCRIPTION OF THE DRAWINGS

FIG. 1 is a schematic illustration of a top-down view of a first exemplary integrated back light unit according to a first embodiment of the present disclosure. The portion of the encapsulating matrix overlying a source-side reflection material layer, a lead structure, or leads is not shown for clarity.

FIG. 2 is a schematic illustration of a vertical cross-sectional view of the first exemplary integrated back light unit according to the first embodiment of the present disclosure.

FIG. 3 is a schematic illustration of a vertical cross-sectional view of a second exemplary integrated back light unit according to a second embodiment of the present disclosure.

FIG. 4 is a schematic illustration of a vertical cross-sectional view of a third exemplary integrated back light unit according to a third embodiment of the present disclosure.

FIG. 5 is a schematic illustration of a vertical cross-sectional view of a fourth exemplary integrated back light unit according to a fourth embodiment of the present disclosure.

FIG. 6 is a schematic illustration of a vertical cross-sectional view of a first variation of the first exemplary integrated back light unit according to the first embodiment of the present disclosure.

FIG. 7 is a schematic illustration of a vertical cross-sectional view of a first variation of the second exemplary integrated back light unit according to the second embodiment of the present disclosure.

FIG. 8 is a schematic illustration of a vertical cross-sectional view of a first variation of the third exemplary integrated back light unit according to the third embodiment of the present disclosure.

FIG. 9 is a schematic illustration of a vertical cross-sectional view of a first variation of the fourth exemplary integrated back light unit according to the fourth embodiment of the present disclosure.

FIG. 10 is a schematic illustration of a vertical cross-sectional view of a second variation of the first exemplary integrated back light unit according to the first embodiment of the present disclosure.

FIG. 11 is a schematic illustration of a vertical cross-sectional view of a second variation of the second exemplary integrated back light unit according to the second embodiment of the present disclosure.

FIG. 12 is a schematic illustration of a vertical cross-sectional view of a second variation of the third exemplary integrated back light unit according to the third embodiment of the present disclosure.

FIG. 13 is a schematic illustration of a vertical cross-sectional view of a second variation of the fourth exemplary integrated back light unit according to the fourth embodiment of the present disclosure.

FIG. 14A is a schematic illustration of a vertical cross-sectional view of a fifth exemplary integrated back light unit according to a fifth embodiment of the present disclosure.

FIG. 14B is a top-down view of the light guide plate within the fifth exemplary integrated back light unit in FIG. 14A.

FIG. 14C is a magnified view of a portion of FIG. 14B.

FIG. 14D is a vertical cross-sectional view of the light guide plate of FIG. 14C along the plane D.

FIG. 14E is a vertical cross-sectional view of the light guide plate of FIG. 14C along the plane E.

FIG. 14F is a vertical cross-sectional view of the light guide plate of FIG. 14C along the plane F.

FIG. 14G is a vertical cross-sectional view of the light guide plate of FIG. 14C along the plane G.

FIG. 15A is a top-down view of a light guide plate of a fifth exemplary integrated back light unit.

FIG. 15B is a magnified view of a portion of FIG. 15A.

FIG. 15C is a magnified view of a portion of FIG. 15B.

FIG. 16 is a set of schematics illustrating an exemplary design for grooves within a light guide plate.

FIG. 17A is a top-down view of a printed circuit board substrate with light emitting diodes bonded and a transparent encapsulant layer thereupon according to an embodiment of the present disclosure.

FIG. 17B is a vertical cross-sectional view of the printed circuit board structure of FIG. 17A.

FIG. 17C is a magnified view of a bonding region of the printed circuit board substrate in an embodiment in which flip chip bonding is employed to bond the light emitting diodes.

FIG. 17D is a magnified view of a bonding region of the printed circuit board substrate in an embodiment in which wire bonding is employed to bond the light emitting diodes.

FIG. 18A is a top-down view of a printed circuit board substrate during dicing into printed circuit board strips to form a lightbar according to an embodiment of the present structure.

FIG. 18B is a vertical cross-sectional view of one of the lightbars in FIG. 18A.

FIG. 19A is a top-down view of an alternate embodiment of a lightbar according to an embodiment of the present disclosure.

FIG. 19B is a vertical cross-sectional view of the lightbar of FIG. 19A.

FIG. 20 is a perspective view of a lightbar according to an embodiment of the present disclosure.

FIG. 21 is a side view of a lightbar assembly that includes a lightbar and a printed circuit adaptor configured for electrical interface according to an embodiment of the present disclosure.

FIG. 22 is a schematic view of an integrated back light unit that incorporates a lightbar assembly according to an embodiment of the present disclosure.

FIG. 23 is a perspective view of an integrated back light unit according to an embodiment of the present disclosure.

FIG. 24 is a top down view of a light guide plate including a pair of corner regions in which extraction features are absent according to an embodiment of the present disclosure.

FIG. 25A is a top-down view of an illumination intensity profile for a comparative light guide plate having a uniform density of extraction features near a light bar.

FIG. 25B is a top-down view of an illumination intensity profile for a light guide plate in which extraction features are removed from corner regions.

### DETAILED DESCRIPTION

As stated above, the present disclosure is directed to an integrated back light unit and a method of manufacturing the same, the various aspects of which are described below. Throughout the drawings, like elements are described by the same reference numerals. The drawings are not drawn to scale. Multiple instances of an element may be duplicated where a single instance of the element is illustrated, unless absence of duplication of elements is expressly described or clearly indicated otherwise. Ordinals such as “first,” “second,” and “third” are employed merely to identify similar elements, and different ordinals may be employed across the specification and the claims of the instant disclosure.

Prior art backlight solutions which utilize LED light sources and intended for uniform illumination applications suffer from degraded overall optical system efficiency due to one or more of the following limitations:
1. Degradation in reliability of an integrated back light unit due to local heating of a component, and especially a local heating of a region (a hot spot generation) of a light guide unit at which high angle rays impinge; and
2. Non-uniformity of brightness due to variations in the light intensity as a function of location, and specifically, as a function of distance from a light emitting device and/or as a function of the type of the light emitting device.

As used herein, an “integrated back light unit” refers to a unit that provides the function of illumination for liquid crystal displays (LCDs) or other devices that display an image by blocking a subset of background illumination from the side or from the back. As used herein, a “light emitting device” can be any device that is capable of emitting light in the visible range (having a wavelength in a range from 400 nm to 800 nm), in the infrared range (having a wavelength in a range from 800 nm to 1 mm), or in the ultraviolet range (having a wavelength is a range from 10 nm to 400 nm). The light emitting devices of the present disclosure include light emitting diodes as known in the art, and particularly the semiconductor light emitting diodes emitting light in the visible range.

As used herein, a “light emitting device assembly” refers to an assembly in which at least one light emitting device is structurally fixed with respect to a support structure, which can include, for example, a substrate, a matrix, or any other structure configured to provide stable mechanical support to the at least one light emitting device. As used herein, a “light guide unit” refers to a unit configured to guide light emitted from at least one light emitting device in a light emitting device assembly in a direction or directions that are substantially different from the initial direction of the light as emitted from the at least one light emitting device. A light guide unit of the present disclosure may be configured to reflect or scatter light along a direction different from the initial direction of the light as emitted from the at least one light emitting device. In one embodiment, the light guide unit of the present disclosure includes a light guide plate, and may be configured to reflect light along directions about the surface normal of the bottom surface of the light guide plate, i.e., along directions substantially perpendicular to the bottom surface of the light guide plate. As used herein, a direction is “substantially perpendicular” to another direction if the angle between the two directions is in a range from 75 degrees to 105 degrees.

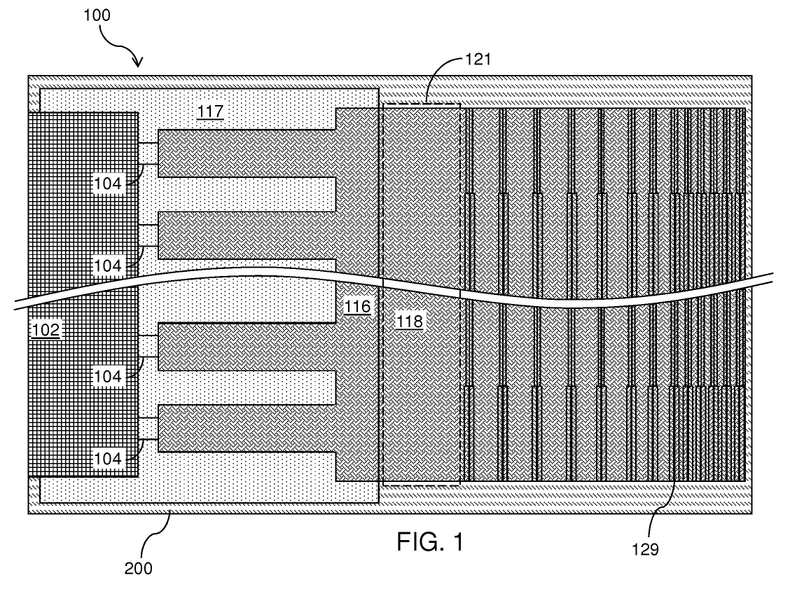

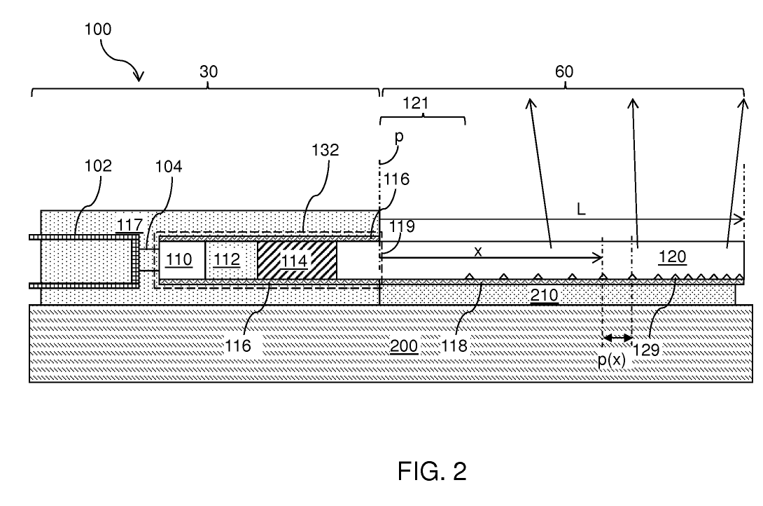

Referring to FIGS. 1 and 2, a first exemplary integrated back light unit 100 is shown, which includes a light emitting device assembly 30, a light guide unit 60, and a substrate 200. The substrate 200 can be an insulator substrate, a semiconductor substrate, a conductive substrate, or a combination or a stack thereof, and can be replaced with any rigid structure that can provide structural support to the light emitting device assembly. The substrate 200 can be an optional component.

The light emitting device assembly 30 can include a support (117, 102, 104) having a shape that defines an interstice 132 therein. The interstice 132 is a cavity having an opening 119 toward a side. In one embodiment, the interstice 132 can have a uniform width in proximity to the opening 119 at the side, and can have as many number of cavity extensions away from the opening 119 as the number of light emitting devices 110 to be embedded within the support (117, 102, 104). Alternately, the number of cavity extensions can be the same as the number of clusters of light emitting devices 110 if a plurality of the light emitting devices 110 are bundled as a cluster. Yet alternately, the cavity extensions can be merged in case the light emitting devices 110 laterally contact one another within the interstice 132.

In one embodiment, the portion of the interstice 132 that is proximal to the opening 119 can contain a substantially rectangular cavity having a uniform width. In another embodiment, the portion of the interstice 132 that is proximal to the opening 119 can be corrugated such that the light guide unit 60 may be inserted into the interstice with precision alignment. The shape of the interstice 132 can be adjusted to accommodate the type, the shape, and the nature of each of the at least one light emitting device 110. In an illustrative example, the interstice 132 may include portions having a slit shape, a cylindrical shape, a conical shape, a polyhedral shape, a pyramidal shape, or any three-dimensional curvilinear shape to accommodate embedding of the at least one light emitting device 110, to accommodate a light path between each of the at least one light emitting device 110 and the opening 119 of the interstice 132, and to accommodate insertion of a portion of the light guide unit 60 into the interstice 132.

A source-side reflective material layer 116 can be formed on at least a portion of the sidewalls of the interstice 132. The source-side reflective material layer 116 can be a layer of a light-reflecting material such as a silver or aluminum. In one embodiment, the source-side reflective material layer 116 can be formed as a coating.

The support (117, 102, 104) can include a lead structure 102 that can be a molded lead frame, a circuit board, or any structure that can house the power supply wiring to each of the at least one light emitting device 110. Further, the support (117, 102, 104) can include leads 104 that provide electrical connection from the lead structure 102 to the various nodes of the at least one light emitting device 110. The support (117, 102, 104) can further include an encapsulating matrix 117, which can be molded to form the interstice 132 therein. In one embodiment, the encapsulating matrix 117 can be a plastic material or a polymer LED package made of an opaque material or an optically transparent material. As used herein, an “optically transparent material” refers to a material that is at least 50% transmissive at the wavelength of the light emitted from the at least one light emitting device 110. As used herein, an “opaque material” refers to any material that is not an optically transparent material. A housing (not shown) may be provided for the encapsulating matrix 117 as needed.

Each of the at least one light emitting device 110 can be inserted into the interstice 132 and embedded within the support (117, 102, 104) such that the electrically active nodes of the at least one light emitting device 110 contact the leads 104. Each light emitting device 110 can be electrically connected to the leads 104 in any suitable technique for bonding or attachment such as flip chip bonding or wire bonding. In one embodiment, each of the at least one light emitting device 110 may include one or more light-emitting semiconductor elements (such as red, green and blue emitting LEDs; blue LEDs, green LEDs, and blue LEDs covered with red emitting phosphor; or blue LEDs, green LEDs, and blue emitting LEDs covered with yellow emitting phosphor).

In one embodiment, the at least one light emitting device 110 can include a white light emitting LED (e.g., a blue LED covered with yellow emitting phosphor which together appear to emit white light to an observer) or plurality of closely spaced LEDs (e.g., a set of closely spaced LEDs emitting red, green, and blue light; a set of closely spaced LEDs including a blue LED, a green LED, and a blue LED covered with red emitting phosphor; or a set of closely spaced LEDs including a blue LED, a green LED, and a blue LED covered with yellow emitting phosphor).

Any suitable LED structure may be utilized for each of the at least one light emitting device 110. In embodiments, the LED may be a nanowire-based LED. Nanowire LEDs are typically based on one or more pn- or pin-junctions. Each nanowire may comprise a first conductivity type (e.g., doped n-type) nanowire core and an enclosing second conductivity type (e.g., doped p-type) shell for forming a pn or pin junction that in operation provides an active region for light generation. An intermediate active region between the core and shell may comprise a single intrinsic or lightly doped (e.g., doping level below 10¹⁶ cm⁻³) semiconductor layer or one or more quantum wells, such as 3-10 quantum wells comprising a plurality of semiconductor layers of different band gaps. Nanowires are typically arranged in arrays comprising hundreds, thousands, tens of thousands, or more, of nanowires side by side on the supporting substrate to form the LED structure. The nanowires may comprise a variety of semiconductor materials, such as III-V semiconductors and/or III-nitride semiconductors, and suitable materials include, without limitation GaAs, InAs, Ge, ZnO, InN, GaInN, GaN, AlGaInN, BN, InP, InAsP, GaInP, InGaP:Si, InGaP:Zn, GalnAs, AlInP, GaAlInP, GaAlInAsP, GalnSb, InSb, AN, GaP and Si. The supporting substrate may include, without limitation, III-V or II-VI semiconductors, Si, Ge, Al₂O₃, SiC, Quartz and glass. Further details regarding nanowire LEDs and methods of fabrication are discussed, for example, in U.S. Pat. Nos. 7,396,696, 7,335,908 and 7,829,443, PCT Publication Nos. WO2010014032, WO2008048704 and WO2007102781, and in Swedish patent application SE 1050700-2, all of which are incorporated by reference in their entirety herein.

Alternatively, bulk (i.e., planar layer type) LEDs may be used instead of or in addition to the nanowire LEDs. Furthermore, while inorganic semiconductor nanowire or bulk light emitting diodes are preferred, any other light emitting devices may be used instead, such as laser, organic light emitting diode (OLED) (including small molecule, polymer and/or phosphorescent based OLED), light emitting electrochemical cell (LEC), chemoluminescent, fluorescent, cathodoluminescent, electron stimulated luminescent (ESL), resistive filament incandescent, halogen incandescent, and/or gas discharge light emitting device. Each light emitting device 110 may emit any suitable radiation wavelength (e.g., peak or band), such as visible radiation.

Optionally, an optically transparent encapsulant portion 112 can be formed on each of the at least one light emitting device 110 within the interstice 132. Further, an optical launch 114 can be formed on each optically transparent encapsulant portion 112 or on each of the at least one optically transparent encapsulant portion 112 as needed. The various materials that can be employed for the optically transparent encapsulant portions 112 or the optical launches 114 are known in the art.

In one embodiment, light-scattering particles can be embedded into the material of the optically transparent encapsulant portion 112. The optically transparent encapsulant portion 112 can encapsulate, and can attach, bars of arrays of red, green and blue (RGB) light-emitting diodes (LED) on to light guide plates (LGP) in various edge-lit displays. The light-scattering particles, also referred to as diffusers, act to effectively mix the light ray bundles emitted from the individual RGB LED emitters entering the LGP, effectively mixing the colors together so that the bar of LEDs and LGP can be assembled into a back light unit that produces a uniform color temperature and brightness. In one embodiment, the diffusers can be mixed into the material of the optically transparent encapsulant portion 112 at a concentration that can be selected to optimize the ray-bundle mixing of the arrays of RGB emitters without excessively attenuating the intensities of the emission.

The size and composition of the particulates used for scattering can be selected to optimize the optical properties of the optically transparent encapsulant portion 112. In one embodiment, titanium oxide (TiO₂) particles can be as the diffusers for LED sources. In one embodiment, the average size (e.g., a diameter) of the diffuser particles can be in a range from 0.5 micron to 10 microns, although lesser and greater sizes can also be employed. In one embodiment, silicone can be employed as the matrix material of the optically transparent encapsulant portion, which functions as an adhesive and an encapsulant material for the diffuser particles.

Each of the encapsulating matrix 117 and the optically transparent encapsulant portion(s) 112 can be at least 80% transmissive at the wavelength(s) of the light emitted from the at least one light emitting device 110. In one embodiment, each of the encapsulating matrix 117 and the optically transparent encapsulant portion(s) 112 can be 80%-99% transmissive at the wavelength(s) of the light emitted from the at least one light emitting device 110. In one embodiment, each of the encapsulating matrix 117 and the optically transparent encapsulant portion(s) 112 can be 80%-99% transmissive over the visible wavelength range. In an illustrative example, the materials for the encapsulating matrix 117 and the optically transparent encapsulant portion(s) 112 may be independently selected from silicone, acrylic polymer (e.g., poly(methyl methacrylate) (“PMMA”), and epoxy. The at least one optical launch 114, if present, may include a phosphor or dye material mixed in with the silicone, polymer, and/or epoxy. In one embodiment, a lightbar as known in the art may be substituted for the light emitting device assembly 30 of the present disclosure.

The light guide unit 60 includes a plurality of extraction features 129 configured to reflect or scatter light from the at least one light emitting device 110. The plurality of light extraction features 129 reflects or scatters light to the front side of the light guide unit 60. The general directions along which the light from the at least one light emitting device 110 is reflected or scattered is illustrated by the three upward-pointing arrows in FIG. 2.

In one embodiment, the light guide unit 60 can include a light guide plate 120, which can be an optically transparent plate having a substantially uniform thickness. In one embodiment, the plurality of extraction features 129 may be located on a surface or, or within, the light guide plate 120. In one embodiment, the plurality of extraction features 129 can be geometrical features on the bottom surface of the light guide plate 120. The geometrical features can include, for example, protrusions and/or recesses on the bottom surface of the light guide plate 120. In one embodiment, each of the geometrical features can have, for example, a prism shape, a pyramidal shape, a columnar shape, a conical shape, or a combination thereof. The geometrical features may be discrete features not adjoined to one another, or may be adjoined to one another to form a contiguous structure. In one embodiment, a dimension of each geometrical feature along the direction of the initial direction of the light rays can be in a range from ¼ of the wavelength of the light emitted from the at least one light emitting device 110 to about 100 times the wavelength of the light emitted from the at least one light emitting device 110, although lesser and grater dimensions can also be employed.

The plurality of extraction features 129 can be printed geometrical features on a surface of the light guide plate 120 to affect the extraction and transmission of photons traveling within the light guide plate 120. The printed feature can be optimized to absorb, reflect, or partially reflect and absorb the photons from the at least one light emitting device 110. The at least one of the printed geometrical features may have a shape selected from a rectilinear shape, a curvilinear shape, a polygonal shape, and a curved shape, and may be optimized to obtain a desired optical emission pattern from the surface of the light guide plate 120. Inkjetting, stenciling or other suitable pattern transferring process can form the desired geometrical features of the extraction features 129. A suitable polymer-based or solvent-based carrier can deliver the desired material for the plurality of extraction features 129 to the surface of the light guide plate 120. The delivered material of the plurality of extraction features 129 can be absorptive, reflective, or partially transmissive.

The light guide unit 60 can further include a backside light reflection layer 118, which is a light reflection layer positioned on the bottom side of the light guide plate 120. The backside light reflection layer 118 functions as a back plate that underlies the light guide plate 120, and reflects light from the at least one light emitting device 100 to the front side of the light guide unit 60. The backside light reflection layer 118 can be a layer of a light-reflecting material such as silver or aluminum, or a coating of a light-reflecting material on a flexible or non-flexible layer. In one embodiment, the backside light reflection layer 118 can include a thermally conductive material such as metal. In one embodiment, a thermally conductive layer 210 can be provided between the backside light reflection layer 118 and the substrate 200 to facilitate heat transfer from the backside light reflection layer 118 to the substrate 200 so that overheating of the backside light reflection layer 118 is avoided.

The light guide unit 60 can be inserted into the interstice 132, or its edge can be positioned next to the opening 119 of the interstice 132, such that the light guide unit 60 is optically coupled to the at least one light emitting device 110 upon insertion into the interstice 132. While a configuration in which the light guide unit 160 is inserted into the interstice 132 is illustrated in FIGS. 1 and 2, the present invention can be practice in a configuration in which the light guide unit 60 is placed adjacent to the interstice 132 in any manner provided that the optical coupling is provided between the at least one light emitting device 110 and the light guide unit 60. Generally, at least a distal portion of the light guide unit 160 extends outside the interstice 132.

In one embodiment, a first portion of the light guide unit 60 can be flexibly positioned within the interstice 132, and a second portion of the light guide unit 60 extends outside the interstice 132. In one embodiment, the second portion of the light guide unit 60 can protrude out of the interstice 132. The first portion of the light guide unit 60 is herein referred to as a proximal portion of the light guide unit 60, and the second portion of the light guide unit 60 is herein referred to as a distal portion of the light guide unit 60.

According to an embodiment of the present disclosure, the pattern and the shape(s) of the plurality of extraction features 129 are selected such that the nearest-neighbor distance among the plurality of extraction features 129 is non-uniform and monotonically decreases with an increase in the distance from the at least one light emitting device 110. In one embodiment, the nearest-neighbor distance among the plurality of extraction features 129 is non-uniform and monotonically decreases with an increase in the distance from the at least one light emitting device 110. For example, the nearest-neighbor distance among the plurality of extraction features 129 is non-uniform and monotonically decreases with an increase in the distance x from the plane p including the boundary between the proximal portion of the light guide unit 60 and the distal portion of the light guide unit 60.

As used herein, the “nearest-neighbor distance” is defined for any position contained within an extraction feature 129 as the shortest distance between a first point selected from points on the outer surfaces of the extraction feature and a second point selected from points on the outer surfaces of any other extraction feature. In one embodiment, at least within the distal portion of the light guide unit 60, the nearest-neighbor distance among the plurality of extraction features 129 is non-uniform and strictly decreases with an increase in the distance from the at least one light emitting device 110. In one embodiment, at least within the distal portion of the light guide unit 60, the nearest-neighbor distance among the plurality of extraction features 129 is non-uniform and strictly decreases with an increased in the distance x from the plane p including the boundary between the proximal portion of the light guide unit 60 and the distal portion of the light guide unit 60. Within a region in which the extraction features 129 are adjoined to one another, the nearest-neighbor distance can be zero.

As used herein, a function is “monotonically decreasing” as a function of a parameter if and only if each of the domain and the range of the function is a subset of real numbers and an increase in the value of the parameter does not induce a positive change in the value of the function for all values of the parameter. As used herein, a function is “monotonically increasing” as a function of a parameter if and only if each of the domain and the range of the function is a subset of real numbers and an increase in the value of the parameter does not induce a negative change in the value of the function for all values of the parameter. As used herein, a function is “strictly decreasing” as a function of a parameter if and only if each of the domain and the range of the function is a subset of real numbers and an increase in the value of the parameter induces a negative change in the value of the function for all values of the parameter. As used herein, a function is “strictly increasing” as a function of a parameter if and only if each of the domain and the range of the function is a subset of real numbers and an increase in the value of the parameter induces a positive change in the value of the function for all values of the parameter.

In one embodiment, the plurality of extraction features 129 can be laterally extend along a horizontal direction perpendicular to the horizontal direction along which the distance from the at least one light emitting device 110, or the distance x from the plane p including the boundary between the proximal portion of the light guide unit 60 and the distal portion of the light guide unit 60, is measured. In this case, the nearest neighbor distance for any arbitrarily selected extraction feature 129 can be the lesser of the two distances to the two neighboring extraction features 129, which is herein defined as a local pitch p(x) of the extraction feature 129. In one embodiment, the extraction features 129 can be prisms or grooves extending along the horizontal direction perpendicular to the horizontal direction along which the distance from the at least one light emitting device 110 is measured. In one embodiment, each of the plurality of extension features 129 can extend along a same direction, and the nearest-neighbor distance can be a pitch between a neighboring pair of extension features.

In one embodiment, the nearest-neighbor distance can change at least by 20% (such as 20%-300%) from an extraction feature 129 that is most proximal to the at least one light emitting device 110 to an extraction feature that is most distal from the at least one light emitting device 110. In another embodiment, the nearest-neighbor distance can change at least by 50% (such as 50%-100%) from an extraction feature 129 that is most proximal to the at least one light emitting device 110 to an extraction feature that is most distal from the at least one light emitting device 110. In yet another embodiment, the nearest-neighbor distance can change at least by a factor of 2 from an extraction feature 129 that is most proximal to the at least one light emitting device 110 to an extraction feature that is most distal from the at least one light emitting device 110.

In case the extraction features 129 have different nearest-neighbor distances for different types of light emitting devices 129, a light emitting device 110 can be selected and the corresponding set of extraction features 129 configured to scatter or reflect light from the selected light emitting device 110 can be identified. The nearest-neighbor distance can be calculated for the corresponding set of extraction features 129 for each light emitting device 110. For example, the at least one light emitting device 110 can be a plurality of light emitting devices 110 that includes a first light emitting device that emits light at a first peak wavelength, and a second light emitting device that emits light at a second peak wavelength that is different from the first peak wavelength. In this case, a first subset of the plurality of extraction features 129 within a path of the light from the first light emitting device and a second subset of the plurality of extraction features 129 within a path of the light from the second light emitting device can differ by shape, size, and/or distribution of the nearest-neighbor distance as a function of the distance from a respective light emitting device. In this case, the nearest-neighbor distance for the first subset of the plurality of extraction features 129 and the nearest-neighbor distance for the second subset of the plurality of extraction features 129 can be different monotonically decreasing functions of the distance from the corresponding at least one light emitting device 110, or of the distance x from the plane p including the boundary between the proximal portion of the light guide unit 60 and the distal portion of the light guide unit 60. The same geometrical features can apply in case more than two types of light emitting devices 110 and/or more than two types of extraction features 129 are employed.

According to an embodiment of the present disclosure, the pattern and the shape(s) of the plurality of extraction features 129 are selected such that the plurality of extraction features 129 is non-uniformly distributed. Specifically, the plurality of extraction features 129 can be distributed with a variable density that monotonically increases with the distance from the at least one light emitting device 110. In this case, the density of the extraction features 129 can monotonically increase with the distance from the at least one light emitting device 110, or with the distance x from the plane p including the boundary between the proximal portion of the light guide unit 60 and the distal portion of the light guide unit 60. In one embodiment, the density of the extraction features 129 can strictly increase with the distance from the at least one light emitting device 110, or with the distance x from the plane p including the boundary between the proximal portion of the light guide unit 60 and the distal portion of the light guide unit 60.

As used herein, the density of extraction features 129 is a macroscopic quantity that can be defined as the total area of extraction features 129 per unit area. The density of extraction features 129 can be measured at any point containing an extraction feature 129. The size of the unit area can be selected to include a statistically significant number of extraction features 129 (e.g., greater than 10). In case the extraction features 129 are randomly distributed, any mathematical and/or statistical technique known in the art can be employed to avoid statistical fluctuations in the density of extraction features 129 and to calculate the density of extraction features 129 as a smoothly varying macroscopic quantity. In case the extraction features 129 have different densities for different types of light emitting devices 129, the density of the extraction features 129 can be calculated for each light emitting device 129 by employing only the extraction features 129 that scatter or reflect light from a selected light emitting device 110 for the purpose of calculation of the density of extraction features 129.

In one embodiment, the density of the extraction features 129 can change at least by 20% (such as 20%-300%) from an extraction feature 129 that is most proximal to the at least one light emitting device 110 to an extraction feature that is most distal from the at least one light emitting device 110. In another embodiment, the density of the extraction features 129 can change at least by 50% (such as from 50% to 100%) from an extraction feature 129 that is most proximal to the at least one light emitting device 110 to an extraction feature that is most distal from the at least one light emitting device 110. In yet another embodiment, the density of the extraction features 129 can change at least by a factor of 2 from an extraction feature 129 that is most proximal to the at least one light emitting device 110 to an extraction feature that is most distal from the at least one light emitting device 110.

In one embodiment, a plurality of types can be present for the light emitting devices 110 and/or for the extraction features 129. For example, the at least one light emitting device 110 can be a plurality of light emitting devices 110 that includes a first light emitting device that emits light at a first peak wavelength, and a second light emitting device that emits light at a second peak wavelength that is different from the first peak wavelength. In this case, a first subset of the plurality of extraction features 129 within a path of the light from the first light emitting device and a second subset of the plurality of extraction features 129 within a path of the light from the second light emitting device can differ by shape, size, and/or distribution of the nearest-neighbor distance as a function of the distance from a respective light emitting device. In this case, each of the density of the extraction features 129 for the first subset of the plurality of extraction features 129 and the density of the extraction features 129 for the second subset of the plurality of extraction features 129 can be a monotonically increasing function of the distance from the at least one light emitting device 110, or of the distance x from the plane p including the boundary between the proximal portion of the light guide unit 60 and the distal portion of the light guide unit 60. The same geometrical features can apply in case more than two types of light emitting devices 110 and/or more than two types of extraction features 129 are employed.

In one embodiment, an extraction-feature-free region 121 can be provided within the portion of the light guide unit 60 that is located adjacent to the opening 119 of the interstice 132. For example, the extraction-feature-free region 121 can be provided within the distal portion of the light guide unit 60. In this case, the extraction-feature-free region 121 can be located within a portion of the distal portion of the light guide unit 60 that adjoins the proximal portion of the light guide unit 60. The extraction-feature-free region 121 is free of any of the plurality of extraction features 129. In other words, no extraction feature 129 is present within the extraction-feature-free region 121. In one embodiment, the extraction-feature-free region 121 can have a length of at least 5% (such as 5%-50%) of a total length L of the distal portion of the light guide unit 60. In another embodiment, the extraction-feature-free region 121 can have a length of at least 10% (such as 10%-40%) of a total length L of the distal portion of the light guide unit 60. In yet another embodiment, the extraction-feature-free region 121 can have a length of at least 20% (such as 20%-30%) of a total length L of the distal portion of the light guide unit 60.

The total length L can be in a range from 5 mm to 50 mm, although lesser and greater distances can be employed for the total length L. In one embodiment, the length of the extraction-free-region 121, as measured along a horizontal direction including a direction of the light from the at least one light emitting device 110, can be greater than twice the maximum among the nearest-neighbor distances of the plurality of extraction features 129. In another embodiment, the length of the extraction-free-region 121 can be greater than 10 times (such as 10 times-1,000 times) the maximum among the nearest-neighbor distances of the plurality of extraction features 129. In yet another embodiment, the length of the extraction-free-region 121 can be greater than 100 times (such as 100 times-300 times) the maximum among the nearest-neighbor distances of the plurality of extraction features 129. In still another embodiment, the length of the extraction-free-region 121 can be greater than 0.5 mm.

During the manufacture of any of the exemplary integrated back light unit, the light guide unit 60 can be disposed into the interstice 132 and onto the at least one light emitting device 110, for example, by sliding the light guide unit 60 into the interstice 132. Alternatively, the light guide plate 120 of the light guide unit 60 can form a butted contact with the encapsulating matrix 117 as long as optical coupling is provided between the light guide plate 120 and the at least one light emitting device 110.

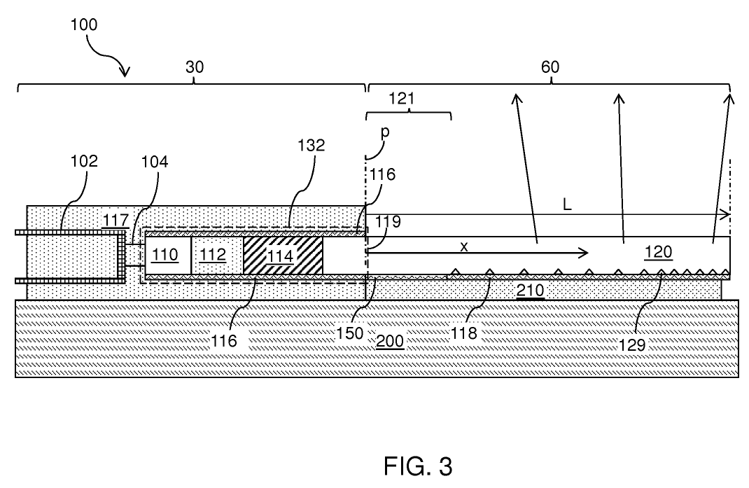

Referring to FIG. 3, a second exemplary integrated back light unit 100 can be derived from the first integrated back light unit 100 by providing a heterogeneous surface on a back plate (150, 118) of the light guide unit 60. In the second exemplary integrated back light unit 100, the backside light reflection layer 118 of the first exemplary integrated back light unit 100 is replaced with a back plate (150, 118) that includes a combination of a specular reflecting material layer 150 and a backside light reflection layer 118. The specular reflecting material layer 150 includes a specular reflecting material. As used herein, “specular reflection” refers the minor-like reflection of light from a surface, in which the angle of incidence is the same as the angle of reflection. A “specular reflecting material” refers to a material that provides specular reflection. A suitable surface finish may be provided on the surface of the specular reflecting material layer 150 to provide specular reflection. The specular reflecting material layer 150 can include any material suitable for use as a mirror.

In one embodiment, the reflectance of the specular reflecting material layer 150 may be greater than the reflectance of the backside light reflection layer 118. In an illustrative example, the backside light reflection layer 118 may include an aluminum layer or a layer of aluminum coating, and the specular reflecting material layer 150 may include a gold layer, a silver layer, a coating of gold, or a coating of silver.

The back plate (150, 118) underlies the light guide plate 120 and has a heterogeneous surface that is proximal to the bottom surface of the light guide plate 120. The heterogeneous surface of the back plate (150, 118) may, or may not, contact the bottom surface of the light guide plate 120. In case the plurality of extraction features 129 is present on the bottom surface of the light guide plate 120, back plate (150, 118) can contact the plurality of extraction features. Specifically, the heterogeneous surface of the back plate (150, 118) can include a distal surface (which is the top surface of the backside light reflection layer 118) that underlies, and optionally contacts, the plurality of extraction features 129, and a proximal surface (which is the top surface of the specular reflecting material layer 150) that is closer to the at least one light emitting device 110 than the distal surface and having a reflectivity different from the distal surface. In one embodiment, the reflectivity of the proximal surface can be greater than the reflectivity of the distal surface.

In one embodiment, the specular reflecting material layer 150 may be located within the area of the extraction-feature-free region 121. The specular reflecting material layer 150 can increase reflection of light from the portion of the back plate (150, 118) that is proximal to the at least one light emitting device 110, and reduce heating of the back plate (150, 118), thereby enhancing the reliability of the second exemplary integrated back light unit 100. Further, if the extraction features 129 are not present over the specular reflecting material layer 150, the absence of the extraction features 129 in the extraction-feature-free region 121 can reduce heating in the portion of the back plate (150, 118) that is proximal to the at least one light emitting device 110.

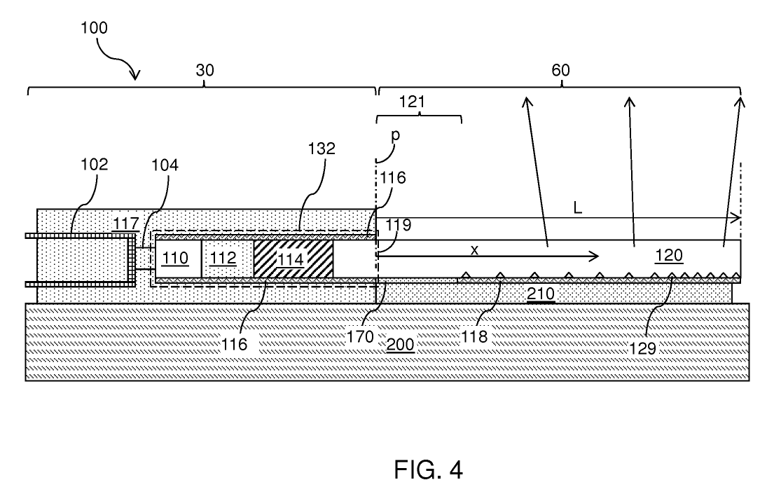

Referring to FIG. 4, a third exemplary integrated back light unit 100 can be derived from the first integrated back light unit 100 by providing a heterogeneous surface on a back plate (170, 118) of the light guide unit 60. In the third exemplary integrated back light unit 100, the backside light reflection layer 118 of the first exemplary integrated back light unit 100 is replaced with a back plate (170, 118) that includes a combination of a diffuse reflecting material layer 170 and a backside light reflection layer 118. The diffuse reflecting material layer 170 includes a diffuse reflecting material. As used herein, “diffuse reflection” refers the reflection of light from a surface such that an incident ray is reflected at many different angles. A “diffuse reflecting material” refers to a material that provides diffuse reflection. A suitable surface finish may be provided on the surface of the diffuse reflecting material layer 170 to provide diffuse reflection. The diffuse reflecting material layer 170 can include any light diffusing material known in the art. The reflectance of the diffuse reflecting material layer 170 may be greater than, equal to or less than, the reflectance of the backside light reflection layer 118.

The back plate (170, 118) underlies the light guide plate 120 and has a heterogeneous surface that is proximal to the bottom surface of the light guide plate 120. The heterogeneous surface of the back plate (170, 118) may, or may not, contact the bottom surface of the light guide plate 120. In case the plurality of extraction features 129 is present on the bottom surface of the light guide plate 120, back plate (170, 118) can contact the plurality of extraction features. Specifically, the heterogeneous surface of the back plate (170, 118) can include a distal surface (which is the top surface of the backside light reflection layer 118) that underlies, and optionally contacts, the plurality of extraction features 129, and a proximal surface (which is the top surface of the diffuse reflecting material layer 170) that is closer to the at least one light emitting device 110 than the distal surface and having a reflectivity different from the distal surface. The reflectivity of the proximal surface can be greater than, equal to, or less than the reflectivity of the distal surface.

In one embodiment, the diffuse reflecting material layer 170 may be located within the area of the extraction-feature-free region 121. The diffuse reflecting material layer 170 may increase reflection of light from the portion of the back plate (170, 118) that is proximal to the at least one light emitting device 110, and reduce heating of the back plate (170, 118), thereby enhancing the reliability of the second exemplary integrated back light unit 100. Further, if the extraction features 129 are not present over the diffuse reflecting material layer 170, the absence of the extraction features 129 in the extraction-feature-free region 121 can reduce heating in the portion of the back plate (170, 118) that is proximal to the at least one light emitting device 110.

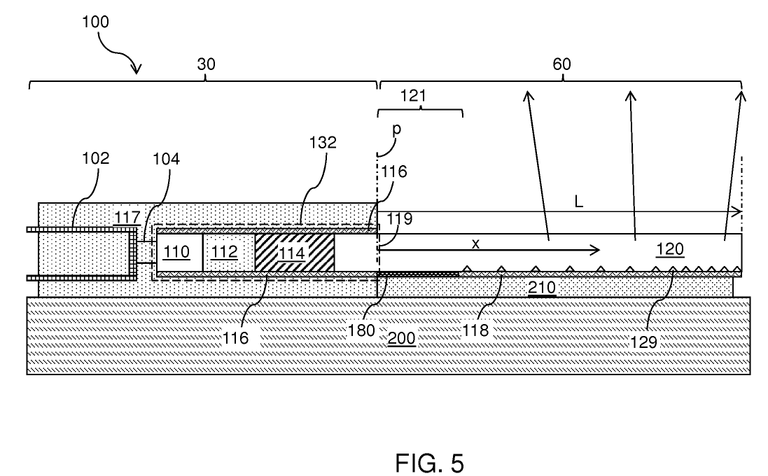

Referring to FIG. 5, a fourth exemplary integrated back light unit 100 can be derived from the first integrated back light unit 100 by providing a heterogeneous surface on a back plate (180, 118) of the light guide unit 60. In the fourth exemplary integrated back light unit 100, the backside light reflection layer 118 of the first exemplary integrated back light unit 100 is replaced with a back plate (180, 118) that includes a combination of a light-absorbing material layer 180 and a backside light reflection layer 118. The light-absorbing material layer 180 includes a light-absorbing material. As used herein, “light-absorbing material” refers to the material having a reflectance less than 0.5 at the wavelength of light impinging thereupon, which can be the wavelength of the light as emitted from the at least one light emitting device 110 or as modified at the optical launch 114. A suitable surface finish may be provided on the surface of the light-absorbing material layer 180 to provide the property of light absorption. The light-absorbing material layer 180 can include any light-absorbing material known in the art, which includes, but is not limited to, black ink, black paint, and a black tape. The reflectance of the light-absorbing material layer 180 is less than the reflectance of the backside light reflection layer 118.

The back plate (180, 118) underlies the light guide plate 120 and has a heterogeneous surface that is proximal to the bottom surface of the light guide plate 120. The heterogeneous surface of the back plate (180, 118) may, or may not, contact the bottom surface of the light guide plate 120. In case the plurality of extraction features 129 is present on the bottom surface of the light guide plate 120, back plate (180, 118) can contact the plurality of extraction features. Specifically, the heterogeneous surface of the back plate (180, 118) can include a distal surface (which is the top surface of the backside light reflection layer 118) that underlies, and optionally contacts, the plurality of extraction features 129, and a proximal surface (which is the top surface of the light-absorbing material layer 180) that is closer to the at least one light emitting device 110 than the distal surface and having a reflectivity different from the distal surface. In one embodiment, the reflectivity of the proximal surface can be lesser than the reflectivity of the distal surface.

In one embodiment, the light-absorbing material layer 180 may be located within the area of the extraction-feature-free region 121. The light-absorbing material layer 180 reduces high angle reflection of the light as emitted from the at least one light emitting device 110. Thus, the light that passes through the portion of the light guide plate 120 overlying the light-absorbing material layer 180 has a lesser angular spread, and therefore, the light reflected or scatted from the extraction features 129 can be more directional, i.e., have a lesser angular spread. In this case, the brightness uniformity of the fourth exemplary integrated back light unit 100 can be enhanced over a comparable unit that does not employ the light-absorbing material layer 180 as a component of the back plate (180, 118). If the extraction features 129 are not present over the light-absorbing material layer 180, the absence of the extraction features 129 in the extraction-feature-free region 121 can reduce heating in the portion of the back plate (180, 118) that is proximal to the at least one light emitting device 110.

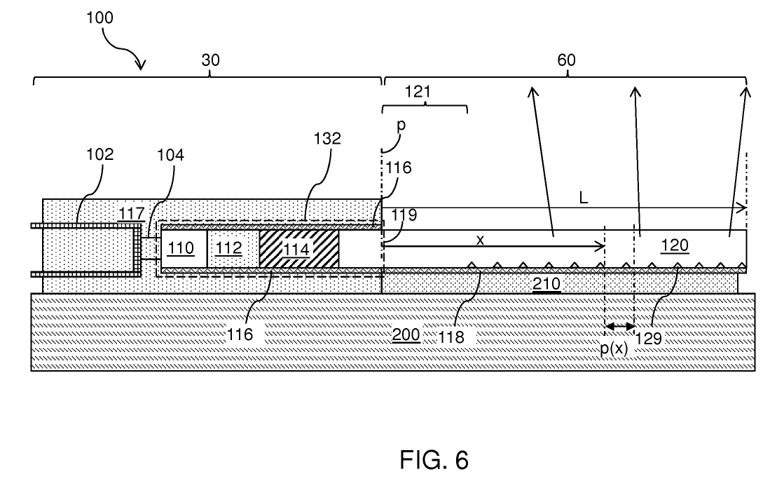

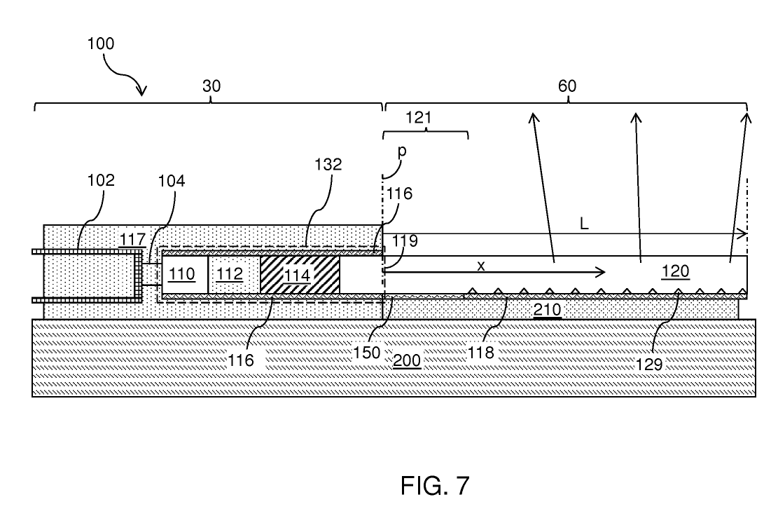

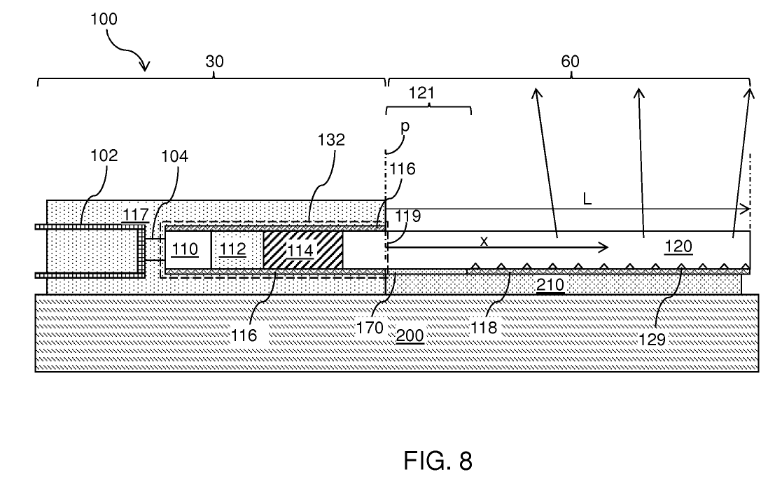

While the features of the present invention are expected to provide full benefit when the various compatible features are employed in conjunction with one another, embodiments are expressly contemplated herein in which one or more of the features are omitted while another feature is utilized. In one embodiment, the feature of non-uniform distribution of extraction features 129 outside the extraction-feature-free region 121 may be omitted in first variations of the various exemplary integrated back light units 100 of the present disclosure. Additionally or alternatively, the feature of the monotonic decrease in the nearest-neighbor distance among the plurality of extraction features 129 with the distance from the at least one light emitting device 110 (or with the distance x from the plane p including the boundary between the proximal portion of the light guide unit (120, 118, 129 and optionally 150, 170, 180) and the distal portion of the light guide unit (120, 118, 129 and optionally 150, 170, 180)) may be omitted in first variations of the various exemplary integrated back light units 100 of the present disclosure. Additionally or alternatively, the feature of the variable density of the plurality of extraction features 129 that monotonically increases with the distance from the at least one light emitting device 110 may be omitted in first variations of the various exemplary integrated back light units 100 of the present disclosure. Such first variations of the various exemplary integrated back light units 100 of the present disclosure are illustrated in FIGS. 6-9, respectively.

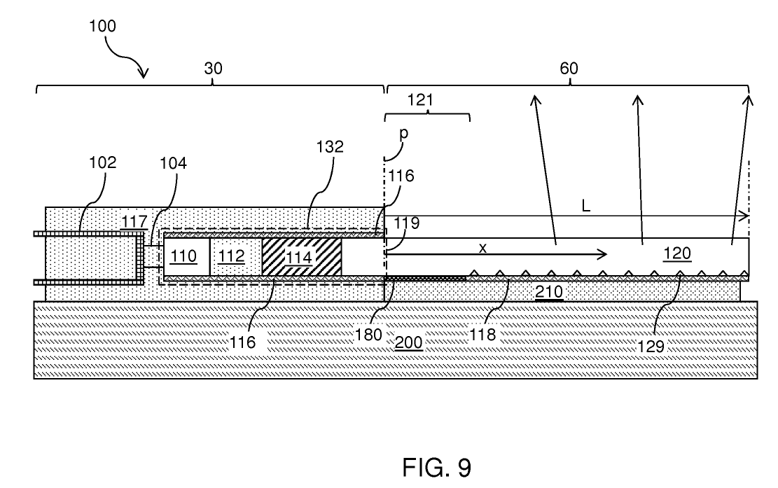

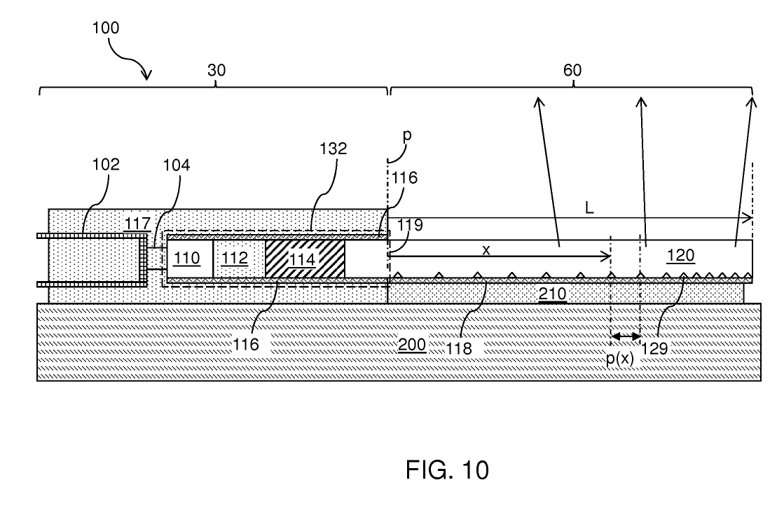

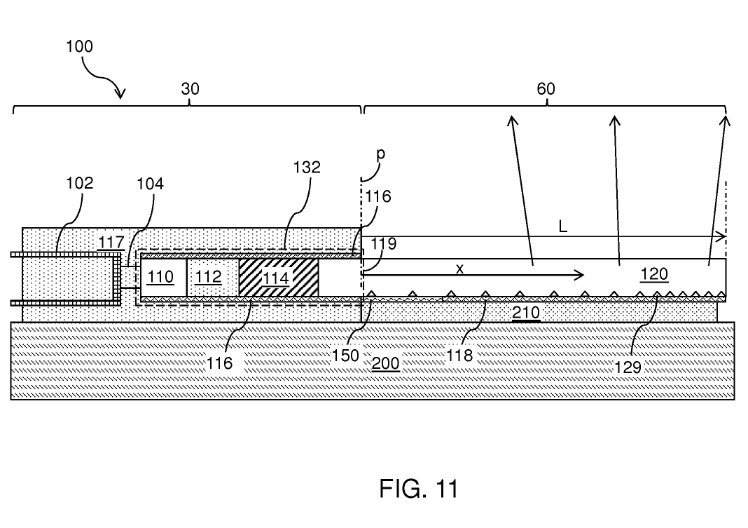

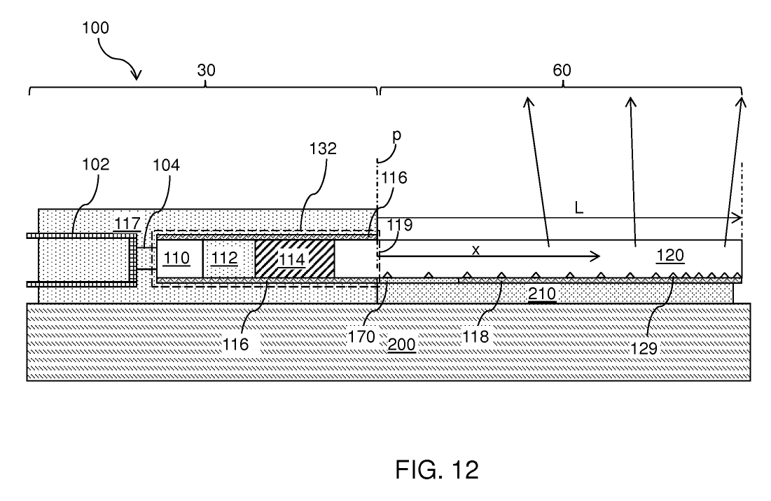

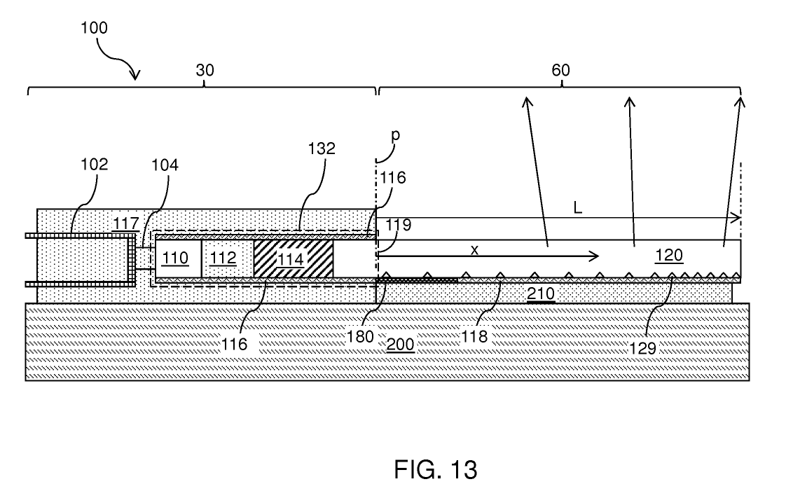

Further, the present invention can be practiced without the feature of the presence of the extraction-feature-free region 121. In other words, the extraction-feature-free region 121 may be eliminated, and the non-uniform distribution of the plurality of extraction features 129 can extend throughout the portion of the light guide plate 120 that protrude out of the light emitting device assembly 30, i.e., out of the plane including the interface between the proximal portion and the distal portion of the light guide unit (120, 118, 129 and optionally 150, 170, 180). Such second variations of the various exemplary integrated back light units 100 of the present disclosure are illustrated in FIGS. 10-13, respectively. An extraction-feature-free region 121 is not present in the second variations of the various exemplary integrated back light units 100 of the present disclosure.

Yet further, the present invention can be practiced without the feature of non-uniform distribution of extraction features 129 and without the feature of the presence of the extraction-feature-free region 121. In other words, the extraction features 129 may be eliminated and the extraction-feature-free region 121 may be eliminated. In this case, third variations of the various exemplary integrated back light units 100 of the present disclosure (not illustrated) can include a heterogeneous surface of a back plate (118 and one or more of 150, 170, 180). The distal surface (which is the top surface of the backside light reflection layer 118) within the heterogeneous surface underlies, and optionally contacts, the plurality of extraction features 129. The proximal surface (which is one or more top surfaces of a specular reflecting material layer 150, a diffuse reflecting material layer 170, and a light-absorbing material layer 180) within the heterogeneous surface is closer to the at least one light emitting device 110 than the distal surface, and can have a reflectivity that different from the reflectivity of the distal surface.

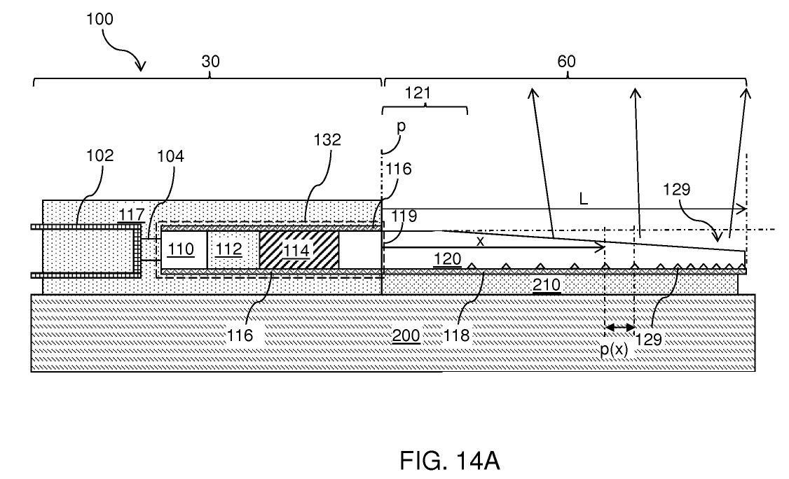

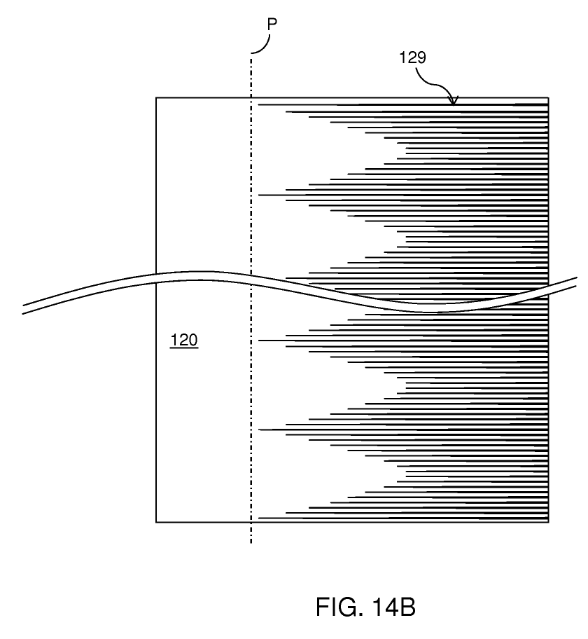

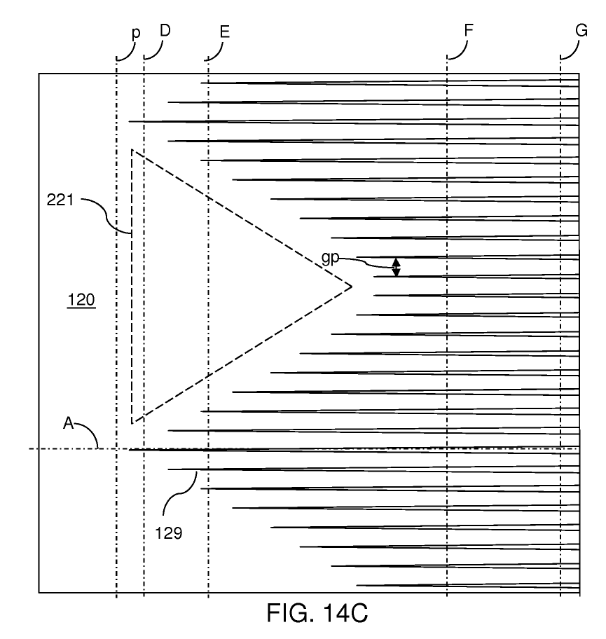

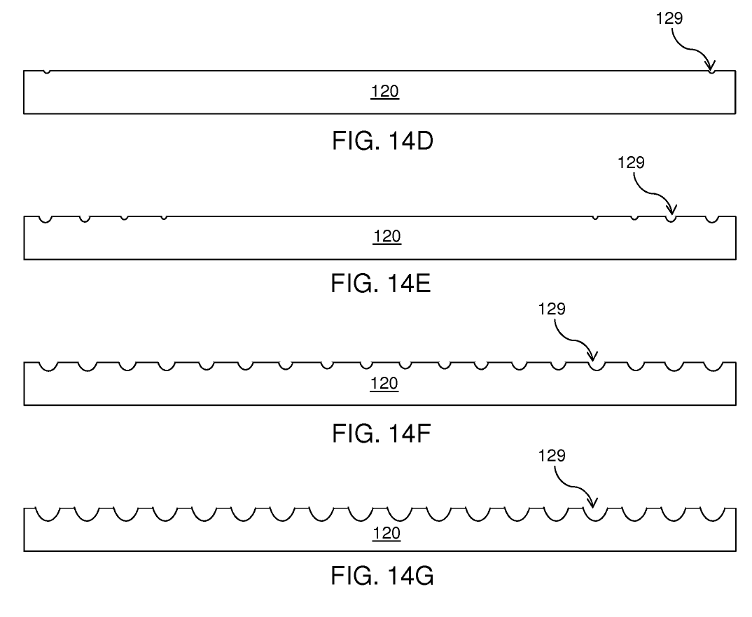

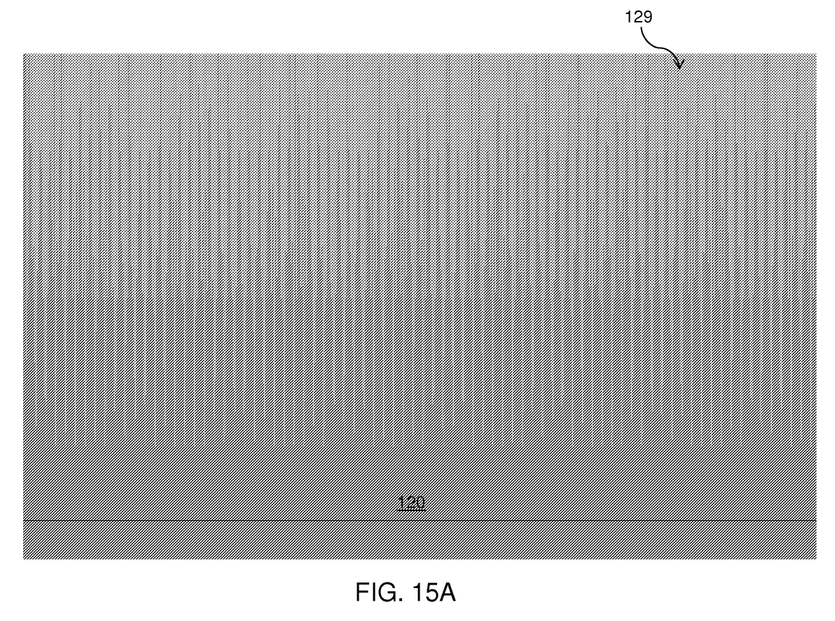

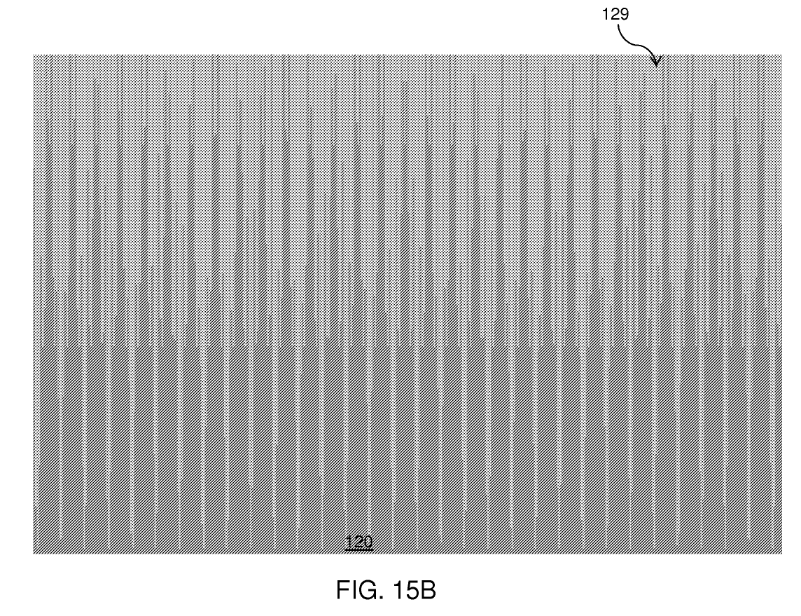

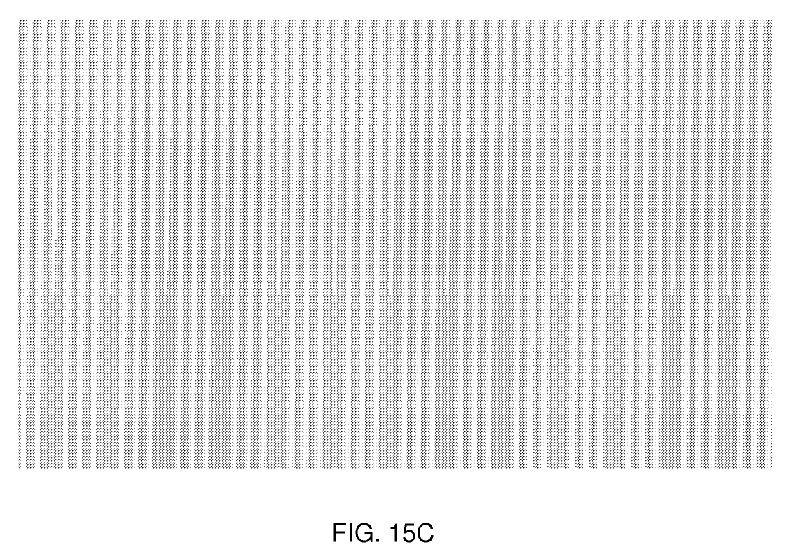

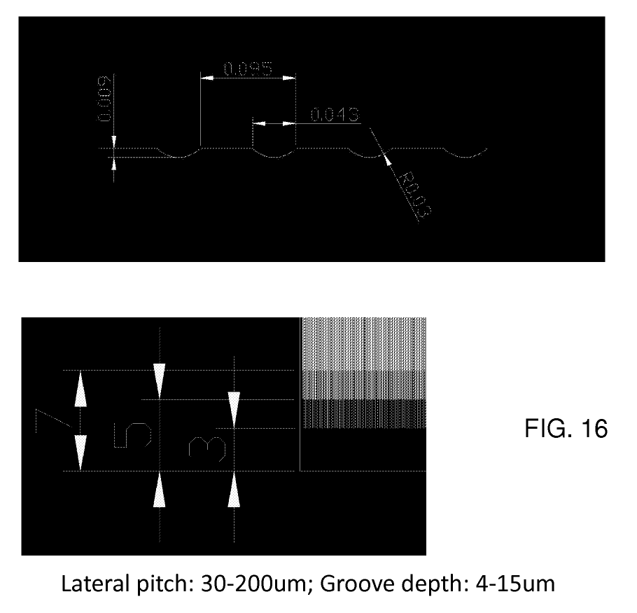

Referring to FIGS. 14A-14G, 15A-15C, and 16, a fifth exemplary integrated back light unit according to a fifth embodiment of the present disclosure is shown, which includes a light guide plate 120 that has grooves 129 on a top surface thereof. In one embodiment, each groove 129 can laterally extend along a direction substantially parallel to the direction of radiation emitted from the at least one light emitting device 110.

In one embodiment, the each groove 129 can laterally extend along a direction substantially parallel to the direction of radiation emitted from the most proximal light emitting device 110 among a plurality of light emitting devices 110. In one embodiment, each groove 129 can have a curved concave vertical cross-sectional profile along a vertical plane perpendicular to the direction of the radiation emitted from the most proximal light emitting device 110. In one embodiment, the vertical cross-sectional profile of each groove 129 can have a circular arc shape or an elliptical arc shape.

In one embodiment, the vertical cross-sectional profile of each groove 129 can set of planar surfaces, which can be, for example, a set of surfaces having a cross-sectional shape of a letter “V” in the Arid font, or a plurality of surfaces having a cross-sectional shape of three or more line segments jointed together to form a generally concave vertical profile when viewed in a vertical cross-sectional view along a plane that is perpendicular to the direction of the radiation emitted from the most proximal light emitting device 110.

In one embodiment, each groove 129 can have a varying depth and a varying width. In one embodiment, the depth of each groove 129 can monotonically increase, or strictly increase, as a function of the lateral distance from the plane p including the boundary between the proximal portion of the light guide unit 60 and the distal portion of the light guide unit 60, or from the at least one light emitting device 110. Additionally or alternatively, the width of each groove 129 can monotonically increase, or strictly increase, as a function of the lateral distance from the plane p including the boundary between the proximal portion of the light guide unit 60 and the distal portion of the light guide unit 60, or from the at least one light emitting device 110. In one embodiment, the maximum depth of each groove 129 can be in a range from 4 microns to 15 microns, although lesser and greater maximum depths can also be employed.

In one embodiment, the rate of increase of the depth of each groove 129 can be inversely proportional to the total length of each groove 129 such that the maximum depths of the grooves 129 can be substantially the same. In one embodiment, the maximum width of each groove 129 can be in a range from 12 microns to 48 microns, although lesser and greater maximum depths can also be employed. In one embodiment, the rate of increase of the width of each groove 129 can be inversely proportional to the total length of each groove 129 such that the maximum widths of the grooves 129 can be substantially the same.

For each neighboring pair of grooves 129, the groove pitch gp between the two vertical planes passing through a respective geometrical center of the grooves 129 and parallel to the direction of the radiation emitted from the most proximal light emitting device 110 can be the same. The groove pitch gp of the grooves can be in a range from 30 microns to 200 microns, although lesser and greater groove pitches gp can also be employed.

In one embodiment, a groove-free region 221 can be provided in proximity to the plane p including the boundary between the proximal portion of the light guide unit 60 and the distal portion of the light guide unit 60, or from the at least one light emitting device 110. The groove-free region 221 can have a substantially triangular shape or a substantially parabolic shape such that the width of the groove-free region 221 monotonically decreases with the lateral distance from the plane p including the boundary between the proximal portion of the light guide unit 60 and the distal portion of the light guide unit 60, or from the at least one light emitting device 110. In one embodiment, the groove-free region 221 may be repeated along a horizontal direction that is perpendicular to the direction of radiation from a plurality of light emitting devices 110 with the same periodicity as the periodicity of repetition of the light emitting devices 110 within the plurality of light emitting devices, or at the periodicity of repetition of a combination of light emitting devices 110 emitting light of different wavelengths and/or combined with different types of optical launch 114.

The plurality of grooves 129 have the effect of concentrating the scattering and/or reflection of the light emitted from the light emitting devices 110 or optical launches 114 within areas in which the grooves 129 are present. By placement of the groove-free regions 221 in regions of the distal portion of the light guide plate 120 that are most proximate to the light emitting devices 110, heating of the regions of the distal portion of the light guide plate 120 that are most proximate to the light emitting devices 110 is avoided, and the temperature of the at least one light emitting device 110 can be maintained at a lower temperature than in a configuration in which the plurality of grooves 129 is not present.

The feature of the plurality of grooves 129 can be combined with any of the first, second, third, and fourth exemplary integrated back light unit and variations thereof. The periodicity of the groove-free regions 221 can be commensurate with the periodicity of light emitting devices 110 within a plurality of light emitting devices 110. In one embodiment, the periodicity of the groove-free regions 221 can be the same as the periodicity of light emitting devices 110 within a plurality of light emitting devices 110. In one embodiment, the periodicity of the groove-free regions 221 can be the same as the periodicity of a combination of light emitting devices 110 of different types that forms a unit of repetition within a plurality of light emitting devices 110.

The structure illustrated in FIGS. 14A-14C comprises an integrated back light, which comprises a light emitting device assembly 30 comprising a support (117, 102, 104) containing an interstice 132 and at least one light emitting device 110 located within the interstice 132; and a light guide unit 60 optically coupled to the at least one light emitting device 30 and having a proximal portion located within, or adjacent to, the interstice 132 and a distal portion extending outside the interstice 132. The light guide unit 60 comprises a plurality of grooves 129 having a linear groove density that increases with a distance x from the proximal portion. The linear groove density is defined as the total number of grooves 129 per unit length as counted within the plane containing the plurality of grooves 129 (e.g., a horizontal plane within which the light propagates inside the light guide unit 60) and along the direction perpendicular to the distance from the proximal portion, i.e., along the direction that is perpendicular to the direction of initial light propagation from the light emitting device 30.

In one embodiment, the light guide unit 60 further comprises an extraction-feature-free region 221 that is free of extraction features and having a width that decreases with the distance x from the proximal portion. The extraction features herein refer to any geometrical features configured to reflect light from the at least one light emitting device 110. The width of the extraction-feature-free region 21 is measured along the direction perpendicular to the distance from the proximal portion, i.e., along the direction that is perpendicular to the direction of initial light propagation from the light emitting device 30. In one embodiment, a plurality of extraction-feature-free regions 221 can be provided. In one embodiment, the extraction-feature-free region(s) can have a shape of a triangle or a shape defined by a parabola on one side and a straight line on another side.

In one embodiment, the linear groove density can increase stepwise with an increase in the distance from the proximal portion up to a predefined distance, which is the distance at which the most distal grooves begin. The linear groove density can remain constant in regions of the light guide 60 in which the distance from the proximal portion is greater than the predefined distance. In one embodiment, each of the plurality of grooves 129 can have a groove depth that increases strictly, i.e., is “strictly increasing,” with the distance from the proximal portion. In one embodiment, each of the plurality of grooves has a groove width that increases strictly with the distance from the proximal portion.

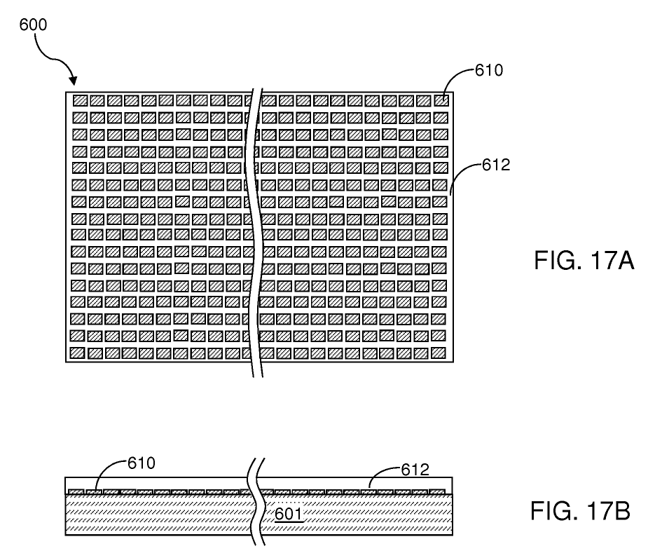

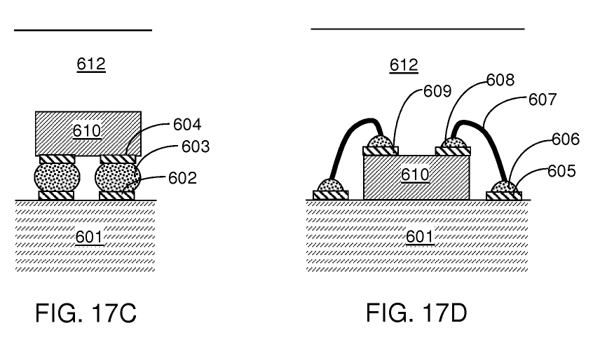

Referring to FIGS. 17A and 17B, a structure according to an embodiment of the present disclosure includes a substrate 601 including metal interconnect structures for providing vertical electrical connections, i.e., electrical connections between electrical nodes at a top surface and respective electrical nodes at a bottom surface. In one embodiment, the substrate 601 can be a printed circuit board substrate that includes metal lines and metal via structures that are formed on an insulating substrate. The front side of the substrate 601 can be provided with substrate contact pads, and the back side of the substrate 601 can be provided with electrical interface structures (such as metal pads).

The top surface of the substrate 601 includes a light-reflecting material. In one embodiment, the substrate 601 can be a flexible printed circuit board substrate having a diffusely reflective white surface (white surface) as disclosed in U.S. Patent Application Publication No. 2013/0163253 Alto Saito et al., the entire contents of which are incorporated herein by reference. Alternatively or additionally, a coating layer including a reflective dielectric material can be provided on the top surface of the substrate 601.

In one embodiment, light emitting devices 610 can be attached to the front side of the substrate 601 in a configuration in which the light emitting devices 610 are arranged in rows separated by channels. The light emitting devices 610 can be any type of light emitting devices. In one embodiment, the light emitting devices 610 can be light emitting diodes. In one embodiment, the light emitting devices 610 can comprise multiple types of light emitting diodes that collectively provide illumination that encompasses the visible light spectrum. The nearest neighbor distance, as measured by a center-to-center distance between a neighboring pair of light emitting devices 610, within each row of light emitting devices 610 can be in a range from 10 microns to 1 mm although lesser and greater nearest neighbor distances can also be employed. In one embodiment, the light emitting devices 610 can be arranges as repetitions of a red-green-blue (RGB) clusters. Each RGB cluster can include a red light emitting device, a green light emitting device, and a blue light emitting device in any arbitrary order. The RGB clusters can be repeated within each row with a uniform pitch, which is herein referred to as an intra-row pitch. The intra-row pitch can be in a range from 30 microns to 4 mm. In one embodiment, the intra-row pitch can be in a range from 50 microns to 3 mm. An intra-row pitch not exceeding 4 nm is generally required in order to mix multiple monochromatic lights without inducing color variations in a light guide plate. The dimension of the substrate 601 along the row direction can be the same as the dimension of lightbars to be fabricated. For example, the dimension of the substrate 601 along the row direction can be in a range from 1 inch to 50 inches, although lesser and greater dimensions can also be employed.

The rows can have a uniform inter-row pitch, i.e., the same center-to-center distance between each neighboring pair of rows. The inter-row pitch is selected to be equal to, or greater than, the sum of the maximum dimension of the light emitting devices 610 along the direction perpendicular to the direction of the rows and within the plane of the top surface of the substrate 601, and the width of a cutting channel to be subsequently formed in a subsequent dicing process that separates each row of light emitting devices 610. The inter-row pitch can be, for example, in a range from 200 microns to 5 mm, although lesser and greater inter-row pitches can also be employed.

A transparent encapsulant layer 612 can be formed over the substrate 601 and the light emitting devices 610. The transparent encapsulant layer 612 includes an optically transparent material that is transparent in the visible light range, which includes a wavelength range from 400 nm to 800 nm. The transparent encapsulant layer 612 can include, for example, silicone, silicon oxide, optically transparent resin, or another optically transparent dielectric material. In one embodiment, the transparent encapsulant layer 612 comprises a material that can function as an elastic molding. For example, silicone can be an elastic molding material that can be employed for the transparent encapsulant layer 612. The transparent encapsulant layer 612 can be formed by a self-planarizing deposition method such as spin coating, or can be planarized by a planarization process (such as chemical mechanical planarization process) after deposition. The thickness of the transparent encapsulant layer 612, as measured from above the topmost surface(s) of the light emitting devices 610, can be in a range from 0.2 mm to 1 mm, although lesser and greater thicknesses can also be employed.

Light emitting diodes 610 can be attached to the front side of the substrate 601 by flip chip bonding, wire bonding, or other bonding methods. FIG. 17C illustrates a configuration in which flip chip bonding is employed to bond the light emitting device s 610 to the substrate 601. Each solder ball 603 can be bonded to a substrate contact pad 602 located on the substrate 601 and to a device contact pad 604 located on a light emitting device 610 to provide flip chip bonding. FIG. 17D illustrates a configuration in which wire bonding is employed to bond the light emitting devices 610 to the substrate 601. A bonding wire 607 can be employed to provide electrical connection between a pair of a substrate contact pad 605 and a device contact pad 608. Solder material portions (606, 608) can be employed to attach each end of the bonding wire 607 to a substrate contact pad 605 or to a device contact pad 608. The transparent encapsulation layer 612 can be formed after all of the light emitting devices 610 are bonded to the substrate 601 to encapsulate the light emitting devices 610.

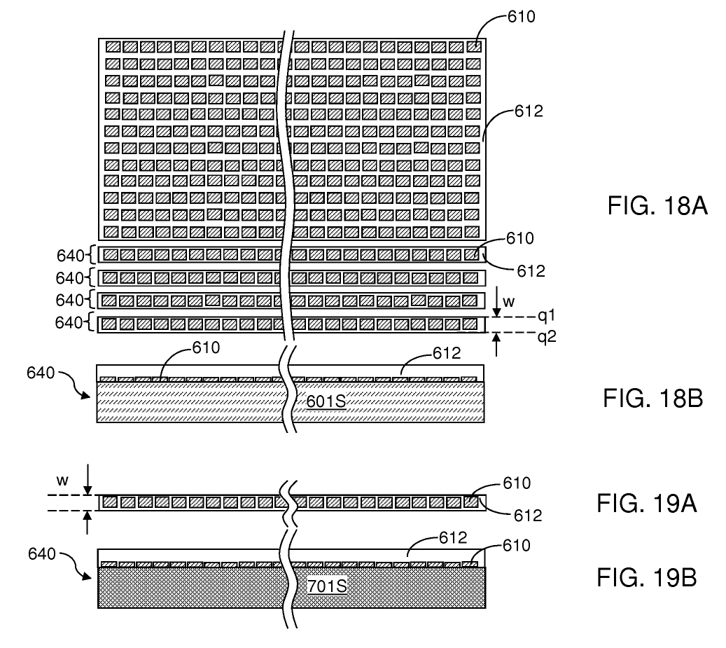

Referring to FIGS. 18A and 18B, the structure including the substrate 601, the light emitting devices 610, and the transparent encapsulant layer 612 can be diced along channels, which are regions between adjacent pairs of rows of the bonded light emitting diodes 610. Each diced portion of the structure (601, 610, 612) is a lightbar 640. Each lightbar 640 includes a substrate strip 601S, which is a diced strip of the substrate 601. Each lightbar 640 can have a uniform width w between a first plane q1 including a first lengthwise sidewall of the substrate strip 601S (such as a printed circuit board strip) and a first lengthwise sidewall of the encapsulant material layer, and a second plane q2 including a second lengthwise sidewall of the substrate strip 601S and a second lengthwise sidewall of the encapsulant material layer 612. The second plane q2 is parallel to the first plane q1. The uniform width w can be in a range from 200 microns to 5 mm, although lesser and greater widths w can also be employed.

In one embodiment, the substrate 601 prior to dicing can be a printed circuit board substrate, and the substrate strip 601S of each light bar 640 can be a printed circuit board strip. Each lightbar 640 comprises a substrate strip 601S, a linear array of light emitting devices 610 located on a front side of the substrate strip 6015, and an encapsulant material layer 612 located on the substrate strip 601S and encapsulating the light emitting devices 610.

Referring to FIGS. 19A and 19B, an alternate embodiment of a lightbar 649 is illustrated. A substrate strip 701S having a uniform thickness can be provided. The substrate strip 701S comprises a dielectric material such as a ceramic material, and embeds metal interconnect structures that provide vertical electrical connections between the top surface of the substrate strip 701S and the bottom surface of the substrate strip. The substrate strip 701S can include a light reflecting dielectric material, or can have a coating of a light reflecting dielectric material. The width w of the substrate strip 701S is not less than the maximum lateral dimension of light emitting devices 610 to be subsequently bonded to the top surface of the substrate strip 7015. For example, the width w of the substrate strip 7015 can be in a range from 200 microns to 5 mm, although lesser and greater inter-row pitches can also be employed.

A linear array of light emitting devices 610 can be attached to the top surface of the substrate strip 7015 by wire bonding, flip chip bonding, or another bonding method. Subsequently, a transparent encapsulant layer 612 can be formed on the top surface of the substrate strip 701S and over the light emitting diodes 610. The transparent encapsulant layer 612 can include, for example, silicone, silicon oxide, optically transparent resin, or another optically transparent dielectric material. In one embodiment, the transparent encapsulant layer 612 comprises a material that can function as an elastic molding. For example, silicone can be an elastic molding material that can be employed for the transparent encapsulant layer 612. Optionally, sidewalls of the lightbar 640 can be polished to provide a pair of parallel planes separated by the width w, for example, by removing portions of the transparent encapsulant layer 612 that laterally extend farther than the sidewalls of the substrate strip 701S that are spaced by the width w.

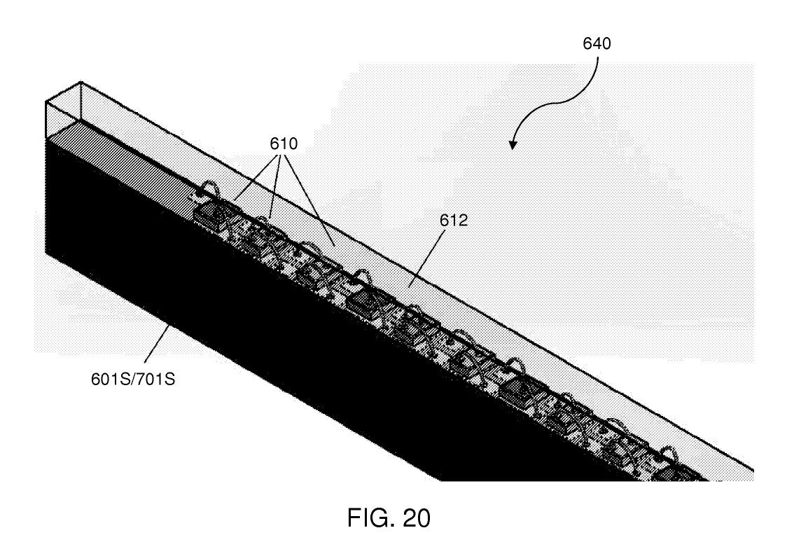

FIG. 20 illustrates a perspective view of a light bar 640, which can be a light bar 640 illustrated in FIGS. 18A and 18B or a light bar 640 illustrated in FIGS. 19A and 19B. In one embodiment, the pattern of the light emitting diodes 610 can be a cyclic pattern in which sets of a red light emitting diode, a green light emitting diode, and a blue light emitting diode are repeated along the direction of the array of the light emitting devices 610.

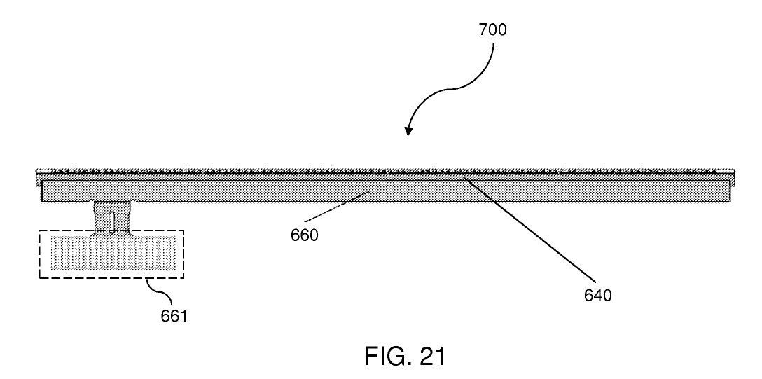

Referring to FIG. 21, a light bar assembly 700 is shown, which can be formed by assembling a lightbar 640 with a printed circuit adaptor 660 that is configured to provide electrical connection to the bottom side of the lightbar 640 and adapted for connected to another circuit board that powers, and drives, the lightbar 640. In one embodiment, the printed circuit adaptor 660 can be a flexible printed circuit including contact fingers 661. In one embodiment, the printed circuit adaptor 660 can comprise an electrical connector configured to provide electrical connections to the lightbar 640. The printed circuit adaptor 660 can be attached to the lightbar 640, for example, by sliding into a tight fit region.

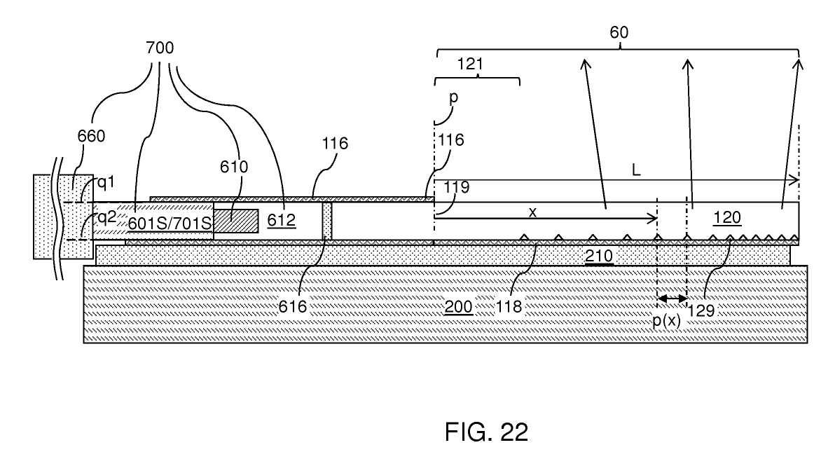

Referring to FIG. 22, the light bar assembly 700 can be assembled with a light guide plate 120 and additional components to form an integrated back light unit. Specifically, a light guide plate 120 can be optically coupled to the light emitting devices 610 by affixing the light guide plate 120 to a top surface of the encapsulant material layer 612. In one embodiment, the light guide plate 120 can be affixed to the top surface of the encapsulant material layer 612 by a transparent adhesive layer 616.

In one embodiment, the transparent adhesive layer 616 can include epoxy or another transparent adhesive resin. Use of the transparent adhesive layer 616 can eliminate any air gap between the light bar assembly 700 and the light guide plate 120, thereby increasing optical coupling efficiency and reducing the amount scattered or reflected light between the light bar assembly 700 and the light guide plate 120.

The light guide plate 120 can comprise a plurality of extraction features 129 configured to reflect light from the light emitting devices 610. The plurality of extraction features 129 can be any of the extraction features 129 discussed above. Further, any or each of the various design features for the light guide plate 120 described above may be incorporated into the light guide plate 120 partly or fully provided that different types of design features for the light guide plate 120 are compatible with one another.

In one embodiment, a first lengthwise sidewall of the substrate strip 601S/701S and a first lengthwise sidewall of the encapsulant material layer 612 can be within a first plane q1, a second lengthwise sidewall of the substrate strip 601S/701S and a second lengthwise sidewall of the encapsulant material layer 612 can be within a second plane q2 that is parallel to the first plane ql. In one embodiment, the substrate strip 601 can be a printed circuit board strip. In another embodiment, the substrate strip 701S can be a ceramic strip embedding interconnect structures for providing electrical connections to the light emitting diodes 610.

According to an embodiment of the present disclosure, an integrated back light unit is provided, which comprises a light emitting device assembly comprising a light bar (601S/701S, 610, 612), a printed circuit adaptor 660, a light guide plate 120, and optionally additional components (200, 210, 118, 116, 616). The light bar (601S/701S, 610, 612) comprises a substrate strip 601S/701S, a linear array of light emitting devices 610 located on the front side of the substrate strip 601S/701S, and an encapsulant material layer 612 located on the substrate strip 601S/701S and encapsulating the light emitting devices 610. The printed circuit adaptor 660 can comprise an electrical connector configured to provide electrical connections to the lightbar (601S/701S, 610, 612). The light guide plate 120 is optically coupled to the light emitting devices 610 and comprises a plurality of extraction features 129 configured to reflect light from the light emitting devices 610. In one embodiment, the light guide plate 120 is attached to the light emitting device assembly 700 by a transparent adhesive layer 616.

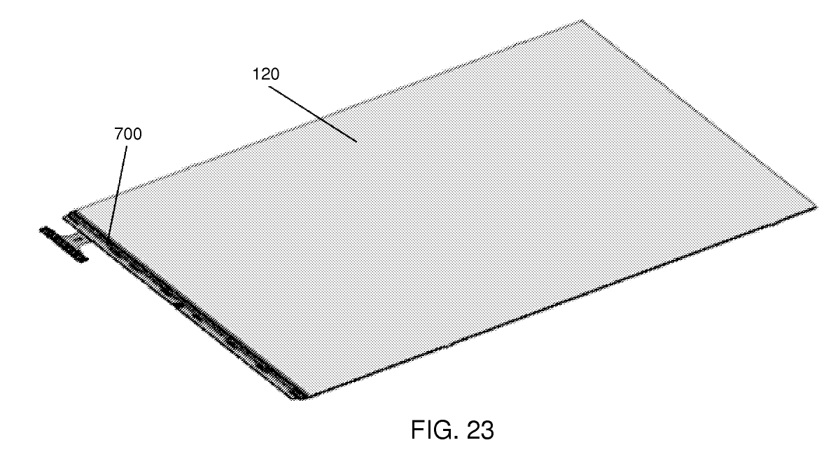

FIG. 23 illustrates a perspective view of the integrated back light unit of FIG. 22.

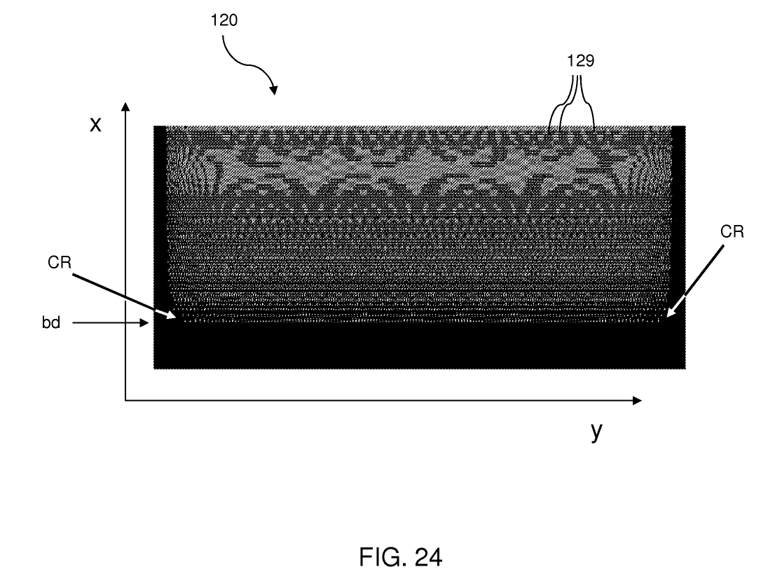

Referring to FIG. 24, a top down view of an exemplary light guide plate 120 is shown. The bottom side of the exemplary light guide plate 120 is the side that engages the light emitting device assembly 30/700 of the various embodiments of the present disclosure. The x direction is the direction of an increasing distance from the light emitting device assembly 30/700. The y direction is a direction that extends along a direction having an equal distance from the light emitting device assembly 30/700. The rectangular outer frame corresponds to the area of the light guide plate 120. The extraction features 129 located within, or on, the light guide plate 120 are illustrated as white dots or white regions. The boundary between a proximal portion of the light guide plate 120 and a distal portion of the light guide plate 120 is marked by the arrow bd. It is understood that the boundary between the proximal portion of the light guide plate 120 and the distal portion of the light guide plate 120 extends along the y direction.

Two regions located at corners of the distal portion of the light guide plate do not include any extraction feature 129 of any type. The two regions are herein referred to “corner regions” CR, in which extraction features 129 of any type are absent. The light guide plate 120 provides an illumination area in the distal portion of the light guide plate 120, i.e., in portions that are not inserted into the interstice 132 or in portions not covered by the source-side reflective material layer 116. The two corner regions CR of the illumination area are free of the plurality of extraction features 129.

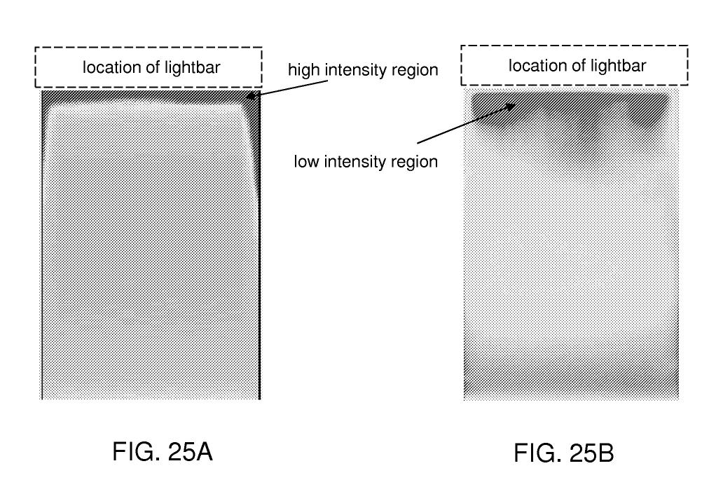

The advantage of the presence of the two corner regions CR that are free of extraction features 129 is illustrated by FIGS. 25A and 25B. FIG. 25A is a top-down view of an illumination intensity profile for a comparative light guide plate having a uniform density of extraction features 129 near a light bar. FIG. 25A shows that the intensity of the light reflected from the extraction features 129 can be high near the two corners on the side of the lightbar when the extraction features are present near the lightbar and at the two corners in proximity to the lightbar. FIG. 25B shows that with elimination of extraction features at the two corners that are proximal to the lightbar can eliminate, or significantly reduce, the area of high intensity region. In addition, reduction of the density of the extraction features 129 near the lightbar can generate low intensity region. Thus, by optimizing the density of the extraction features 129 near the lightbar, and by forming corner regions CR that are free of extraction features 129, it is possible to provide a more uniform illumination across the entirety of the illumination area that corresponds to the distal portion of the light guide plate 120.

The design feature of a pair of corner regions CR that are free of any extraction features can be incorporated into any of the light guide plates 120 described above to enhance uniformity of the illumination intensity profile of any integrated back light unit of the present disclosure.

The various embodiments of the present disclosure can be employed to control hot spots in an integrated back light unit and/or to provide more uniform brightness and/or to reduce spatial spread of the reflected light from the extraction features, and may be employed in any configuration expressly described above or otherwise derivable.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. Where an embodiment employing a particular structure and/or configuration is illustrated in the present disclosure, it is understood that the present invention may be practiced with any other compatible structures and/or configurations that are functionally equivalent provided that such substitutions are not explicitly forbidden or otherwise known to be impossible to one of ordinary skill in the art.

What is claimed is:

1. An integrated back light unit, comprising:
a light emitting device assembly comprising a support containing an interstice and at least one light emitting device located within said interstice; and
a light guide unit optically coupled to said at least one light emitting device and having a proximal portion located within, or adjacent to, said interstice and a distal portion extending outside said interstice, said light guide unit comprising a plurality of extraction features configured to reflect light from said at least one light emitting device, wherein a nearest-neighbor distance among said plurality of extraction features is non-uniform and monotonically decreases with an increase in a distance from said at least one light emitting device.

2. The integrated back light unit of claim 1, wherein a region of said distal portion that adjoins said proximal portion and having a length of at least 5% of a total length of said distal portion is free of extraction features.

3. The integrated back light unit of claim 1, wherein said nearest-neighbor distance changes at least by 20% from an extraction feature that is most proximal to said at least one light emitting device to an extraction feature that is most distal from said at least one light emitting device.

4. The integrated back light unit of claim 1, wherein said at least one light emitting device comprises:
a first light emitting device that emits light at a first peak wavelength; and
a second light emitting device that emits light at a second peak wavelength that is different from said first peak wavelength,
wherein a first subset of said plurality of extraction features within a path of said light from said first light emitting device and a second subset of said plurality of extraction features within a path of said light from said second light emitting device differ by shape, size, or distribution of said nearest-neighbor distance as a function of said distance from a respective light emitting device.

5. The integrated back light unit of claim 1, wherein each of said plurality of extraction features laterally extends along a same direction, and said nearest-neighbor distance is a pitch between a neighboring pair of extraction features.

6. The integrated back light unit of claim 1, wherein said light guide unit comprises a light guide plate, and said plurality of extraction features comprises protrusions or recesses on a surface of said light guide plate.

7. The integrated back light unit of claim 6, further comprising a back plate underlying said light guide plate and having a heterogeneous surface, said heterogeneous surface containing:
a distal surface that underlies said plurality of extraction features; and
a proximal surface that is closer to said at least one light emitting device and having a reflectivity different from said distal surface.

8. The integrated back light unit of claim 7, wherein said proximal surface has a specular reflecting material.

9. The integrated back light unit of claim 7, wherein said proximal surface has a diffuse reflecting material.

10. The integrated back light unit of claim 7, wherein said proximal surface has a light-absorbing material.

11. The integrated back light unit of any one of claims 1-10, further comprising light-scattering particles embedded into an encapsulant located over the at least one light emitting device.

12. The integrated back light unit of claim 1, wherein said light guide plate provides an illumination area in said distal portion of said light guide plate, wherein two corner regions of said illumination area are free of said plurality of extraction features.

13. An integrated back light unit, comprising:
a light emitting device assembly comprising a support containing an interstice and at least one light emitting device located within said interstice; and
a light guide unit optically coupled to said at least one light emitting device and having a proximal portion located within, or adjacent to, said interstice and a distal portion extending outside said interstice, said light guide unit comprising:
a plurality of extraction features configured to reflect light from said at least one light emitting device; and
a heterogeneous surface including a distal surface that underlies said plurality of extraction features, and a proximal surface that is closer to said at least one light emitting device and having a reflectivity different from said distal surface.

14. The integrated back light unit of claim 13, wherein said proximal surface has a specular reflecting material.

15. The integrated back light unit of claim 13, wherein said proximal surface has a diffuse reflecting material.

16. The integrated back light unit of claim 13, wherein said proximal surface has a light-absorbing material.

17. The integrated back light unit of claim 13, wherein no extraction feature is present over said proximal surface.

18. The integrated back light unit of claim 13, wherein a nearest-neighbor distance among said plurality of extraction features is non-uniform and monotonically decreases with an increase in a distance from said at least one light emitting device.

19. The integrated back light unit of claim 18, wherein said plurality of extraction features laterally extend along a same direction, and said nearest-neighbor distance is a pitch between a neighboring pair of extraction features.

20. The integrated back light unit of claim 13, wherein said light guide unit comprises a light guide plate, and said plurality of extraction features comprises protrusions or recesses on a surface of said light guide plate.

21. The integrated back light unit of claim 13, wherein said heterogeneous surface is a surface of a back plate underlying said light guide plate.

22. The integrated back light unit of claim 13, wherein said at least one light emitting device comprises:
a first light emitting device that emits light at a first peak wavelength; and
a second light emitting device that emits light at a second peak wavelength that is different from said first peak wavelength,
wherein a first subset of said plurality of extraction features within a path of said light from said first light emitting device and a second subset of said plurality of extraction features within a path of said light from said second light emitting device differ by shape, size, or distribution of said nearest-neighbor distance as a function of said distance from a respective light emitting device.

23. The integrated back light unit of any one of claims 13-22, further comprising light-scattering particles embedded into an encapsulant located over the at least one light emitting device.

24. The integrated back light unit of claim 13, wherein said light guide plate provides an illumination area in said distal portion of said light guide plate, wherein two corner regions of said illumination area are free of said plurality of extraction features.

25. An integrated back light unit, comprising:
a light emitting device assembly comprising a support containing an interstice and at least one light emitting device located within said interstice; and
a light guide unit optically coupled to said at least one light emitting device and having a proximal portion located within, or adjacent to, said interstice and a distal portion extending outside said interstice, said light guide unit comprising a plurality of extraction features which are printed geometrical features on a surface of a light guide plate to affect said extraction and transmission of photons traveling within said light guide plate, said printed feature being optimized to absorb, reflect, or partially reflect and absorb said photons, at least one of said printed geometrical features having a shape selected from a rectilinear shape, a curvilinear shape, a polygonal shape, and a curved shape and optimized to obtain a desired optical emission pattern from said surface of said light guide plate.

26. The integrated back light unit of claim 25, further comprising light-scattering particles embedded into an encapsulant located over the at least one light emitting device.

27. The integrated back light unit of claim 25, wherein said light guide plate provides an illumination area in said distal portion of said light guide plate, wherein two corner regions of said illumination area are free of said plurality of extraction features.

28. An integrated back light unit, comprising:
a light emitting device assembly comprising a support containing an interstice and at least one light emitting device located within said interstice; and
a light guide unit optically coupled to said at least one light emitting device and having a proximal portion located within, or adjacent to, said interstice and a distal portion extending outside said interstice,
wherein said light guide unit comprises a plurality of grooves having a linear groove density that increases with a distance from said proximal portion, said linear groove density being a total number of grooves per unit length as counted within a plane containing said plurality of grooves and along a direction perpendicular to said distance from said proximal portion.

29. The integrated back light unit of claim 28, wherein said light guide unit further comprises an extraction-feature-free region that is free of extraction features and having a width that decreases with said distance from said proximal portion, said extraction features being any geometrical features configured to reflect light from said at least one light emitting device.

30. The integrated back light unit of claim 28, wherein said linear groove density increases stepwise with an increase in said distance from said proximal portion up to a predefined distance, and said linear groove density remains constant in regions of said light guide in which said distance from said proximal portion is greater than said predefined distance.

31. The integrated back light unit of claim 28, wherein each of said plurality of grooves has a groove depth that increases strictly with said distance from said proximal portion.

32. The integrated back light unit of claim 31, wherein each of said plurality of grooves has a groove width that increases strictly with said distance from said proximal portion.

33. The integrated back light unit of any one of claims 28-32, further comprising light-scattering particles embedded into an encapsulant located over the at least one light emitting device.

34. The integrated back light unit of claim 28, wherein said light guide plate provides an illumination area in said distal portion of said light guide plate, wherein two corner regions of said illumination area are free of said plurality of extraction features.

35. An integrated back light unit, comprising:
a light emitting device assembly comprising a light bar, a printed circuit adaptor, and a light guide plate,
wherein said light bar comprises:
a substrate strip comprising metal interconnect structures,
a linear array of light emitting devices located on a front side of said substrate strip, and
an encapsulant material layer located on said substrate strip and encapsulating said light emitting devices;
wherein a first lengthwise sidewall of said substrate strip and a first lengthwise sidewall of said encapsulant material layer are within a first plane, a second lengthwise sidewall of said substrate strip and a second lengthwise sidewall of said encapsulant material layer are within a second plane that is parallel to said first plane;
the printed circuit adaptor comprises an electrical connector configured to provide electrical connections to said lightbar; and
the light guide plate is optically coupled to said light emitting devices and comprises a plurality of extraction features configured to reflect light from said light emitting devices.

36. The integrated back light unit of claim 35, wherein a nearest-neighbor distance among said plurality of extraction features is non-uniform and monotonically decreases with an increase in a distance from said at least one light emitting device.

37. The integrated back light unit of claim 35, wherein a heterogeneous surface including a distal surface that underlies said plurality of extraction features, and a proximal surface that is closer to said at least one light emitting device and having a reflectivity different from said distal surface.

38. The integrated back light unit of claim 35, which are printed geometrical features on a surface of a light guide plate to affect said extraction and transmission of photons traveling within said light guide plate, said printed feature being optimized to absorb, reflect, or partially reflect and absorb said photons, at least one of said printed geometrical features having a shape selected from a rectilinear shape, a curvilinear shape, a polygonal shape, and a curved shape and optimized to obtain a desired optical emission pattern from said surface of said light guide plate.

39. The integrated back light unit of claim 35, wherein said plurality of extraction features comprises a plurality of grooves having a linear groove density that increases with a distance from said proximal portion, said linear groove density being a total number of grooves per unit length as counted within a plane containing said plurality of grooves and along a direction perpendicular to said distance from said proximal portion.

40. The integrated back light unit of claim 35, wherein said light guide plate is attached to said light emitting device assembly by a transparent adhesive layer.

41. The integrated back light unit of claim 35, further comprising a backside light reflection layer comprising a light-reflecting material and contacting a back side of said light guide plate and said light emitting device at said second plane.

42. The integrated back light unit of claim 35, wherein said light guide plate provides an illumination area, wherein two corner regions of said illumination area are free of said plurality of extraction features.

43. The integrated back light unit of any one of claims 35-42, further comprising light-scattering particles embedded into the encapsulant material layer.

44. A method of fabricating a light emitting device assembly, comprising:
bonding a plurality of light emitting devices onto a printed circuit board substrate;
encapsulating said light emitting devices by forming a transparent encapsulant layer on said plurality of light emitting devices;
forming lightbars by dicing an assembly of said printed circuit board substrate, said plurality of light emitting devices, and said transparent encapsulant layer; and
attaching a printed circuit adaptor to a lightbar, said printed circuit adaptor comprising an electrical connector configured to provide electrical connections to said lightbar.

45. The method of claim 44, wherein said plurality of light emitting devices are bonded to said printed circuit board by flop chip bonding or by wire bonding.

46. The method of claim 44, wherein said plurality of light emitting devices are arranged in rows separated by channels and having a uniform pitch upon bonding to said printed circuit board substrate.

47. A method of forming an integrated back light unit, comprising:
providing a lightbar comprising a substrate strip, a linear array of light emitting devices located on a front side of said substrate strip, and an encapsulant material layer located on said substrate strip and encapsulating said light emitting devices;
forming a light emitting device assembly by attaching said lightbar to a printed circuit adaptor comprising an electrical connector configured to provide electrical connections to said lightbar; and
optically coupling a light guide plate to said light emitting devices by affixing the light guide plate to a top surface of the encapsulant material layer, said light guide plate comprising a plurality of extraction features configured to reflect light from said at least one light emitting device.

48. The method of claim 47, wherein the light guide plate is affixed to the top surface of the encapsulant material layer by a transparent adhesive layer.

49. The method of claim 47, wherein a first lengthwise sidewall of said substrate strip and a first lengthwise sidewall of said encapsulant material layer are within a first plane, a second lengthwise sidewall of said substrate strip and a second lengthwise sidewall of said encapsulant material layer are within a second plane that is parallel to said first plane.

50. The method of claim 47, wherein the substrate strip is a printed circuit board strip.

51. The method of claim 47, wherein the substrate strip is a ceramic strip embedding interconnect structures for providing electrical connections to the light emitting diodes.

52. The method of any one of claims 44-51, further comprising light-scattering particles embedded into the encapsulant layer.
